(19) United States
(12) Patent Application Publication
(10) Pub. No.: US 2018/0122189 A1
(43) Pub. Date: May 3, 2018

(54) Software Application with Multiplier Trail

(71) Applicant: Pridefield Limited, Douglas (GB)

(72) Inventor: Jonathan Bruce Wortmann, Ballarat (AU)

(21) Appl. No.: 15/796,380

(22) Filed: Oct. 27, 2017

(30) Foreign Application Priority Data
Oct. 31, 2016 (GB) 1618353.5

(51) Int. Cl. G07F 17/32; G07F 17/34

(52) U.S. Cl. CPC G07F 17/3267; G07F 17/3244; G07F 17/3225; G07F 17/3213; G07F 17/34

(57) ABSTRACT

An embodiment may involve a software application executed on behalf of a client machine with a graphical display unit, the software application graphically displaying animations that simulate spinning a plurality of reels. The embodiment may involve determining that a trigger event occurred, and determining a number of spins of the reels, where a multiplier is set to an initial value. The embodiment may involve carrying out iterations of operations comprising: selecting a set of symbols associated with positions of each of the reels, where the multiplier is increased in response to any non-winning outcome, and the multiplier is reset to the initial value in response to a winning outcome; and causing the graphical display unit to display an animation that simulates a spin of the reels that results in displaying the set of symbols, and the win multiplier increasing when a non-winning outcome appears in the set of symbols.

### CROSS-REFERENCE TO RELATED APPLICATION

This application claims priority to U.K. patent application no. 1618353.5, filed Oct. 31, 2016, which is hereby incorporated by reference in its entirety.

### BACKGROUND

Wager games come in a variety of forms, including for example a mechanical slot machine. A mechanical slot machine may include one or more reels, each of which includes a fixed pattern of symbols distributed around the circumference of the reel. When a player places a wager (e.g., by placing a coin in the machine), the player is allowed to spin the reels. Each reel then comes to rest, typically with either one of the symbols, or a space in between symbols, in alignment with a pay line. A predefined winning symbol or a predefined combination of winning symbols that are aligned with the pay line can result in the player winning the game and receiving a payout. In one example, the machine may include three reels, and the pay line may be a horizontal line disposed across a centre of each of the three reels.

In another example of a wager game, a mechanical slot machine may present symbols in a matrix arrangement, with each symbol changing during a spin of the game according to the fixed pattern of symbols on the reels. For example, the machine may have five columns and three rows of symbols, for a total of fifteen symbols. Such machines often have multiple pay lines, each being defined by a collection of positions within the matrix. For instance, the machine may have three pay lines, each corresponding to one row of the matrix.

### SUMMARY

While slot machines were traditionally mechanical, modern slot machines often take the form of a video gaming machine (e.g., a dedicated gaming machine located in a casino) that includes a graphical user interface (GUI), and that may emulate a mechanical slot machine. With a video gaming machine, the GUI may display an image of one or more reels or a matrix as described above, together with animation effects to simulate a spin of the one or more reels, or a spin of the columns or rows of the matrix. A computer software program, which may reside in the video gaming machine, may randomly select one or more symbols in response to a spin, and may display the selected one or more symbols on the display.

A modern slot machine may also be played over a computer network, such as by a player using a client machine that is connected to a server machine by the computer network. In this instance, the server machine may perform the spins of the game and may send data representing the resulting symbols to the client machine, thereby instructing the client machine to display the symbols.

The popularity of video slot games has increased due to the incorporation of novel features, such as win multipliers, into such games. A win multiplier may be used to multiply winnings when an outcome of a spin includes a winning symbol combination. The win multiplier may be incremented when an outcome of a spin does not include a winning symbol combination. Thus, the win multiplier may assist in increasing payouts from winning results and may provide a player with entertainment and additional opportunities to win games.

Viewed from a first aspect, the disclosure provides a computer-implemented method that involves a gaming machine determining that a trigger event for a bonus game occurred during a base outcome event of a base game. The base game and the bonus game are both reel-based games being executed on behalf of a client machine. Both the base game and the bonus game involve spinning a plurality of reels, each reel containing a respective plurality of symbols, to determine outcome events. A memory of the gaming machine stores respective pluralities of symbols for the reels. In response to determining that the trigger event occurred, the gaming machine awards a number of spins of the reels in an instance of the bonus game. A win multiplier associated with the bonus game is set to an initial value. Until the awarded number of bonus game spins have been performed, the gaming machine repeatedly carries out iterations of bonus game operations. The operations include selecting a set of symbols associated with respective positions of each of the reels as an outcome event of a respective iteration of the bonus game. The value of the win multiplier is increased in response to a non-winning outcome of the respective iteration of the bonus game. The value of the win multiplier is reset to the initial value in response to a winning outcome of the respective iteration of the bonus game. The operations also include transmitting, to the client machine, a representation of the selected set of symbols. Reception of the selected set of symbols causes the client machine to display the bonus game spin of the plurality of reels resulting in the selected set of symbols. The gaming machine carries out one or more additional iterations of the bonus game until a further winning outcome occurs. The value of the win multiplier is increased in response to a further non-winning outcome of an iteration of the additional iterations of the bonus game.

Viewed from a second aspect, the disclosure provides a computer-implemented method for symbol selection in a reel-based game. The reel-based game is executed by a gaming machine on behalf of a client machine. The reel-based game involves spinning a plurality of reels to determine outcome events. A memory of the gaming machine stores respective pluralities of symbols for the reels. The reel-based game includes selecting a first set of symbols associated with respective positions of each of the reels. The first set of symbols represents an outcome event of a base game of the reel-based game. The first set of symbols is stored in the memory. It may be determined that the outcome event includes a trigger event that causes execution of a bonus game. The bonus game includes a predetermined number of bonus outcome events. In response to determining that the outcome event includes the trigger event, a second set of symbols associated with respective positions of each of the reels is selected as a bonus outcome event of the reel-based game. A win multiplier associated with the bonus game is set to an initial value. The second set of symbols is stored in the memory. The value of the win multiplier is adjusted. In particular, the value of the win multiplier is increased in response to a non-winning bonus outcome event. The value of the win multiplier is reset to the initial value in response to a winning bonus outcome event. It may be determined that the predetermined number of bonus outcome events have been performed, and, in response, one or more additional bonus outcome events of the reel-based game are performed until a further winning outcome occurs. The value of the win multiplier is increased in response to a further non-winning outcome of an iteration of the one or more additional bonus outcome events.

Viewed from a third aspect, the disclosure provides an article of manufacture including a non-transitory computer-readable medium, having stored thereon program instructions that, upon execution by a gaming machine, cause the gaming machine to perform the operations of the first and/or second aspect.

Viewed from a fourth aspect, the disclosure provides a gaming machine configured to perform the operations of the first and/or second aspect.

Viewed from a fifth aspect, the disclosure provides a system comprising means for performing the operations of the first and/or second aspect.

Viewed from a sixth aspect, the disclosure provides a gaming system that comprises a plurality of gaming devices each including at least one display device and a plurality of input devices including: (i) an acceptor of a physical item associated with a monetary value, (ii) a validator configured to identify the physical item, and (iii) a cash-out button actuatable to cause an initiation of a payout associated with a credit account; one or more gaming device processors; and one or more gaming device memory devices storing (i) respective pluralities of symbols for the reels and (ii) a plurality of gaming device instructions. The gaming device instructions are executable by the one or more gaming device processors to perform the operations of the first and/or second aspect.

In embodiments of the disclosure in which a computer software product is used, the product may be non-transitory and store instructions on physical media such as a DVD, or a solid state drive, or a hard drive. Alternatively, the product may be transitory and in the form of instructions provided over a connection such as a network connection which is linked to a network such as the Internet.

These aspects, as well as other embodiments, aspects, advantages, and alternatives will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE FIGURES

FIG. 1 is a simplified block diagram of a machine, in accordance with example embodiments.

FIG. 2 is a simplified block diagram of an example server machine connected to an example client machine over a computer network, in accordance with example embodiments.

FIG. 3 depicts diagrams of tables that may be used with the processes, machines, and systems herein, in accordance with example embodiments.

FIG. 4 depicts elements displayable by a display of a machine, in accordance with example embodiments.

FIG. 5 depicts an example of a selected symbol set in a display, in accordance with example embodiments.

FIG. 6A is a first part of a flow chart, in accordance with example embodiments.

FIG. 6B is a second part of the flow chart of FIG. 6A, in accordance with example embodiments.

FIG. 6C is a third part of the flow chart of FIG. 6A, in accordance with example embodiments.

FIG. 6D is a fourth part of the flow chart of FIG. 6A, in accordance with example embodiments.

FIG. 7 depicts an example of a selected bonus symbols set in a display, in accordance with example embodiments.

FIG. 8 depicts an example of another selected bonus symbols set in a display, in accordance with example embodiments.

FIG. 9A depicts an example of a further selected bonus symbols set in a display, in accordance with example embodiments.

FIG. 9B depicts an example of an additional selected bonus symbols set in a display, in accordance with example embodiments.

FIG. 10A depicts an example of a yet another selected bonus symbols set in a display, in accordance with example embodiments.

FIG. 10B depicts an example of a yet further selected bonus symbols set in a display, in accordance with example embodiments.

FIG. 11A is a first part of a flow chart, in accordance with example embodiments.

FIG. 11B is a second part of the flow chart of FIG. 11A, in accordance with example embodiments.

FIG. 11C is a third part of the flow chart of FIG. 11A, in accordance with example embodiments.

FIG. 11D is a fourth part of the flow chart of FIG. 11A, in accordance with example embodiments.

FIG. 12A is a first part of a flow chart, in accordance with example embodiments.

FIG. 12B is a second part of the flow chart of FIG. 12A, in accordance with example embodiments.

FIG. 12C is a third part of the flow chart of FIG. 12A, in accordance with example embodiments.

FIG. 13 is a flow chart, in accordance with example embodiments.

FIG. 14 is a flow chart, in accordance with example embodiments.

FIG. 15 depicts elements displayable by a display of a machine, in accordance with example embodiments.

FIG. 16 depicts elements displayable by a display of a machine, in accordance with example embodiments.

FIG. 17 depicts elements displayable by a display of a machine, in accordance with example embodiments.

### DETAILED DESCRIPTION

### I. Introduction

This description describes several example embodiments including, but not limited to, example embodiments pertaining to performing aspects of an outcome event using a machine. Performing the outcome event can include playing a game. The machine can display a variety of symbols during performance of an outcome event. A symbol displayed within a symbol-display-portion of a display during an outcome event may be replaced by another symbol. The replacement symbols can be used to determine a payout amount for an outcome event in which a wager is won.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Disclosed herein are machines, systems, and methods for carrying out aspects of outcome events that include displaying symbols. These aspects may be incorporated into games, in particular, wager games. In one aspect, the machines, systems, and methods provide a feature that may enhance traditional wager games (e.g., slot machines or other reel-type games) by providing a player with additional opportunities to win the game, thereby increasing the player's interest, anticipation, and excitement in connection with the game. This may in turn benefit a casino or another entity that provides a game with this feature. Indeed, wager games are typically configured to have odds that favour the casino (sometimes referred to as the “house”). Accordingly, based on the law of averages, casinos often increase their profits simply by getting more players to play more games. Due to the provided features, players may be drawn in (e.g., from competing casinos that lack games with such a feature) and they may play the game often. The feature can include new data communications between a server machine and a client machine within a server-client based configuration.

### II. Example Architecture

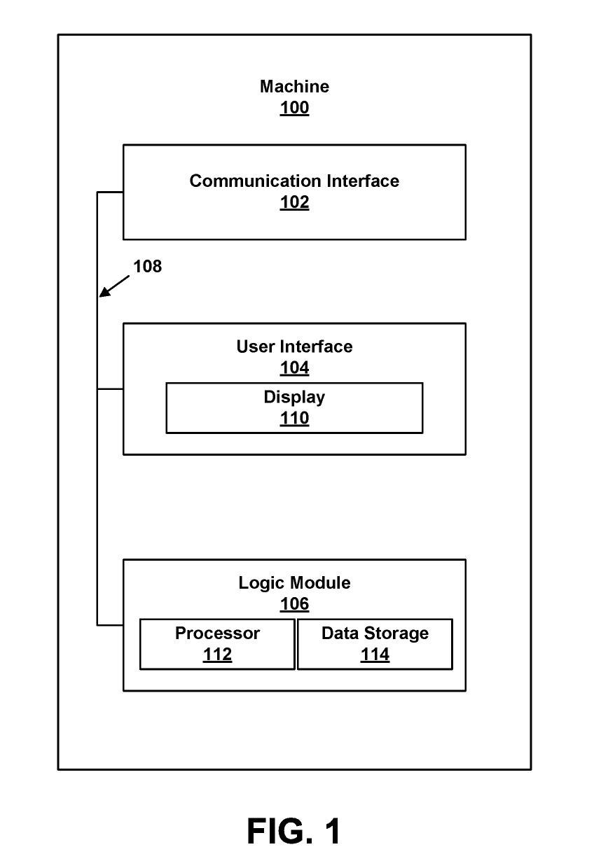

FIG. 1 shows a simplified block diagram of an example machine 100 arranged to implement operations in accordance with example methods described herein. Machine 100 may take any of a variety of forms, including for example a dedicated gaming machine, a personal computer, a server computer, a personal digital assistant, a mobile phone, a tablet device, or some other computing device.

Machine 100 may include a communication interface 102, a user interface 104, and a logic module 106, all of which may be coupled together by a system bus, network, or other connection mechanism 108. The communication interface 102 may include a wired or wireless network communication interface. For purposes of this description, any data described as being provided, sent, or transmitted by machine 100 can be data sent by communication interface 102 over a communication network. Also, for purposes of this description, any data described as being received by machine 100 can be data sent to communication interface 102 over a communication network.

The user interface 104 may facilitate interaction with a user (e.g., a player of a game) if applicable. As such, the user interface 104 may take the form of a GUI and may include output components such as a speaker and a display 110, and input components such as a keypad, keyboard, mouse, or a touch-sensitive screen. As described in greater detail below, display 110 may be configured to show, among other things, a symbol set in a game or a portion thereof.

The logic module 106 can take the form of a processor 112 and a data storage 114. The processor 112 can include a general-purpose processor (e.g., a microprocessor) or a special-purpose processor (e.g., a digital signal processor or an application specific integrated circuit) and may be integrated in whole or in part with the communication interface 102 or the user interface 104. Any processor discussed in this description or shown in the drawings can be referred to as a computer-readable processor. Any data storage discussed in this description or shown in the drawings can be referred to as computer-readable data storage.

Data storage 114 may include volatile or non-volatile storage components and may be integrated in whole or in part with processor 112. Data storage 114 may take the form of a non-transitory computer-readable medium and may include software program instructions, that when executed by processor 112, cause machine 100 to perform one or more of the operations described herein. Any software program instructions discussed in this description or shown in the drawings can be referred to as computer-readable program instructions, or more simply, program instructions.

Data storage 114 may also include operating system software on which machine 100 may operate. For example, machine 100 may operate on a Windows®-based operating system (e.g., Windows 7 or Windows 10) provided by the Microsoft® Corporation of Redmond, Wash. Other examples of operating systems are possible.

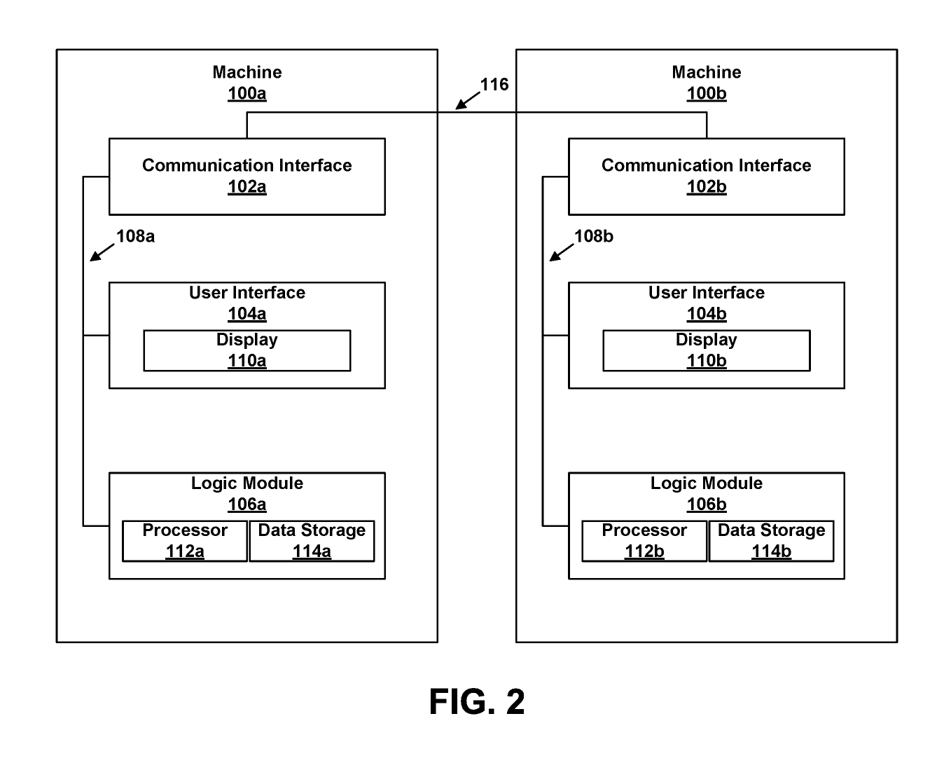

FIG. 2 is a simplified block diagram of an example server machine 100a connected to an example client machine (sometimes referred to as a workstation) 100b over a communication network 116. A configuration of elements including server machine 100a and client machine 100b can be referred to as a server-client based configuration.

The components of the server machine 100a and the client machine 100b are shown with corresponding “a” and ““b” reference numerals (i.e., based on machine 100). Server machine 100a includes communication interface 102a, user interface 104a (which incorporates display screen 110a), logic module 106a (which incorporates processor 112a and data storage 114a), and communication bus 108a. Likewise, client machine 100b includes communication interface 102b, user interface 104b (which incorporates display screen 110b), logic module 106b (which incorporates processor 112b and data storage 114b), and communication bus 108b.

The server machine 100a is configured to communicate with the client machine 100b over communication network 116 (via the communication interfaces 102a, 102b). Likewise, the client machine 100b is configured to communicate with the server machine 100a over the communication network 116. For purposes of this description, any data described as being sent or transmitted by the server machine 100a can be data sent by communication interface 102a over communication network 116. Similarly, any data described as being sent or transmitted by the client machine 100b can be data sent by communication interface 102b over communication network 116. Furthermore, for purposes of this description, any data described as being received by the server machine 100a can be data the server machine 100a receives from the communication network 116 using communication interface 102a. Similarly, any data described as being received by the client machine 100b can be data the client machine 100b receives from the communication network 116 using communication interface 102b.

The communication network 116 for the server-client based configuration described above may take a variety of forms. For example, the communication network 116 may be a local area network (LAN) in a casino, such that client machines 100b dispersed throughout the casino may communicate with the server machine 100a in the casino.

In another example, the communication network 116 may be a wide-area network (WAN), such as an Internet network or a network of the World Wide Web. In such a configuration, the client machine 100b may communicate with the server machine 100a via a website portal (for a virtual casino) hosted on the server machine 100a. The data described herein as being transmitted by server machine 100a to client machine 100b or by client machine 100b to server machine 100a can be transmitted as datagrams according to the user datagram protocol (UDP), the transmission control protocol (TCP), or another protocol.

The communication network 116 may include any of a variety of network topologies and network devices, and may employ traditional network-related technologies, including for example the public switched telephone network, cable networks, cellular wireless networks, WiFi, and WiMAX. Further, the communication network 116 may include one or more databases (e.g., a player credit account database), to allow for the storing and retrieving of data related to performing an outcome event by a machine, as well as adjusting account balances associated with client machines.

In some examples, machine 100 may include an acceptor of a physical item associated with a monetary value, such as a paper money acceptor, coin acceptor, or a card reader. This acceptor may include a validator configured to identify the physical item, and determine whether the physical item is suitable as payment to the machine.

In some examples, machine 100 may also physically dispense a corresponding payout (e.g., cash), or otherwise facilitate the payout to the player (by adding funds to an electronic account associated with a gaming card). Such an activity may be triggered by a cash out button either on display 110 or elsewhere on machine 100. Additionally or alternatively to determining the payout amount, machine 100 may perform other actions to award the player. For instance, the machine may display an indication of a tangible prize. Other types of awards may be used as well.

For purposes of this description, any operation listed in a sentence including the words the “machine 100 can cause,” the “server machine 100a can cause,” or the “client machine 100b can cause” can be carried out, at least in part, as a result of that particular machine executing software program instructions. Those software program instructions can be stored within data storage 114, 114a, or 114b.

Data storage 114, 114a, and 114b can also store data. As an example, a global symbol group for a reel-based game may include multiple symbols, such as a WILD, an ace, a king, a queen, a jack and a ten that may be used in connection with the outcome event, such as a wager game. The ace, king, queen, jack and ten symbols can represent symbols found on a standard deck of playing cards. The WILD symbol may have special properties that allow it to form winning combinations with other symbols.

However, such a global symbol group may be customized with particular symbols as desired. As some possible examples, the symbols may include images of people, animals, dinosaurs, fanciful creatures, cartoon characters, inanimate objects, or other things in addition to or instead of WILD, ace, king, queen, jack, or ten symbols. Furthermore, WILD symbols may vary in design. Examples of some possible symbols are shown in the accompanying drawings.

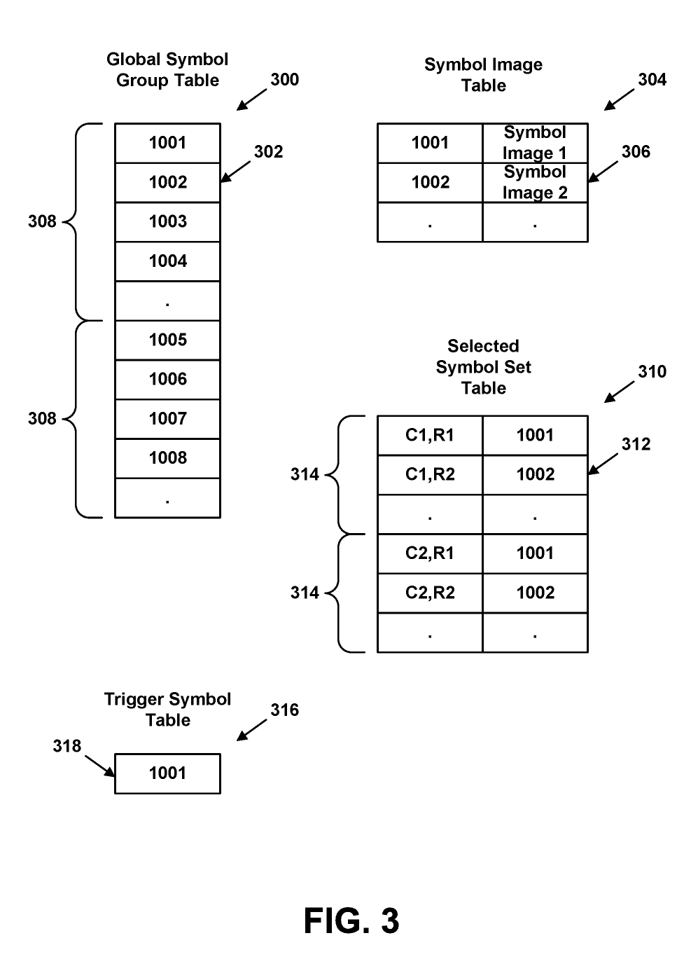

In one example, the global symbol group may be represented as a table (or other data structure) stored in data storage 114. FIG. 3 shows an example global symbol group table 300. The global symbol group table 300 includes multiple records 302, each including an identifier (e.g., 1001, 1002, 1003 1004, etc.) that represents a particular symbol. In one example, the global symbol group, and therefore the global symbol group table 300, may be divided into multiple sub-groups 308 as discussed in greater detail below.

The global symbol group table 300 may be used in connection with a symbol image table 304. The symbol image table 304 includes multiple records 306 (shown as distinct rows of table 304), each including an identifier that represents a particular symbol, and a corresponding displayable image. As such, the symbol image table 304 may be used to map an identifier in the global symbol group table 300 to a displayable image. Such an image may be arranged according to the Joint Photographic Experts Group (JPEG), Graphics Interchange Format (GIF), or Portable Network Graphics (PNG) encodings, for example.

During the course of a game, various symbol sets may be selected for display. Each selected symbol set may be stored in a table such as selected symbol set table 310. Selected symbol set table 310 includes multiple records 312 (shown as distinct rows in selected symbol set table 310), each record including an arrangement position of the symbol, and an identifier that represents the symbol. As such, each symbol in the selected symbol set may correspond with a respective arrangement position in a display arrangement (e.g., both a column number and a row number in a column-and-row arrangement). As an example, C1,R1, shown in the selected symbol set table 310, represents a symbol position at column 1 (e.g., a left-most column of a plurality of columns in a symbol-display-portion of display 110) and row 1 (e.g., a top row of a plurality of rows in a symbol-display-portion of display 110). The column identifiers in selected symbol set table 310 (e.g., C1 and C2) can refer to columns in a symbol matrix or reels of a plurality of reels that can be spun.

In one example, machine 100 may select the first symbol set by iterating through each record 312 in the selected symbol set table 310, and selecting a symbol identifier from among the symbol identifiers in the global symbol group table 300. In some examples, the symbol identifiers are numbers and machine 100 uses a random number generator to select such numbers, and therefore to randomly select symbols.

In some examples, machine 100 may select each subset in the first symbol set from the corresponding sub-group in the global symbol group. This type of selection may be used when the symbol set represents one or more reels in a reel-type wager game. In this instance, each sub-group includes all the symbols of a given reel, and the selected sub-set includes the symbols of the reel that are “in play,” namely those included in the selected symbol set.

In some examples, the selected symbol set may be partially restricted. For instance, the selected symbol set may include an instance of a predetermined symbol from the global symbol group, for example, a WILD symbol. In another example, the predetermined symbol may be in a subgroup of global symbol group table 300 distinct from the subgroups from which symbols for the reels are selected.

As noted above, for each symbol in the selected first symbol set, the example embodiments can include machine 100 randomly determining a corresponding arrangement position. As such, in an example where the arrangement is a column-and-row arrangement, machine 100 may randomly determine a column identifier and a row identifier (from a set of potential column identifier and row identifier combinations) for each symbol in the selected first symbol set. In an example where the arrangement has symbol position identifiers (e.g., whole number 1 through 15, inclusive, as described above), machine 100 may randomly select a symbol position identifier for each symbol in the selected first symbol set.

Where the column and row arrangement is used to simulate reels, machine 100 may display the each subset in a corresponding column, such as by superimposing each subset over a virtual reel in a corresponding column. Thus, a sub-group 308 may represent an ordering of symbols on a particular reel.

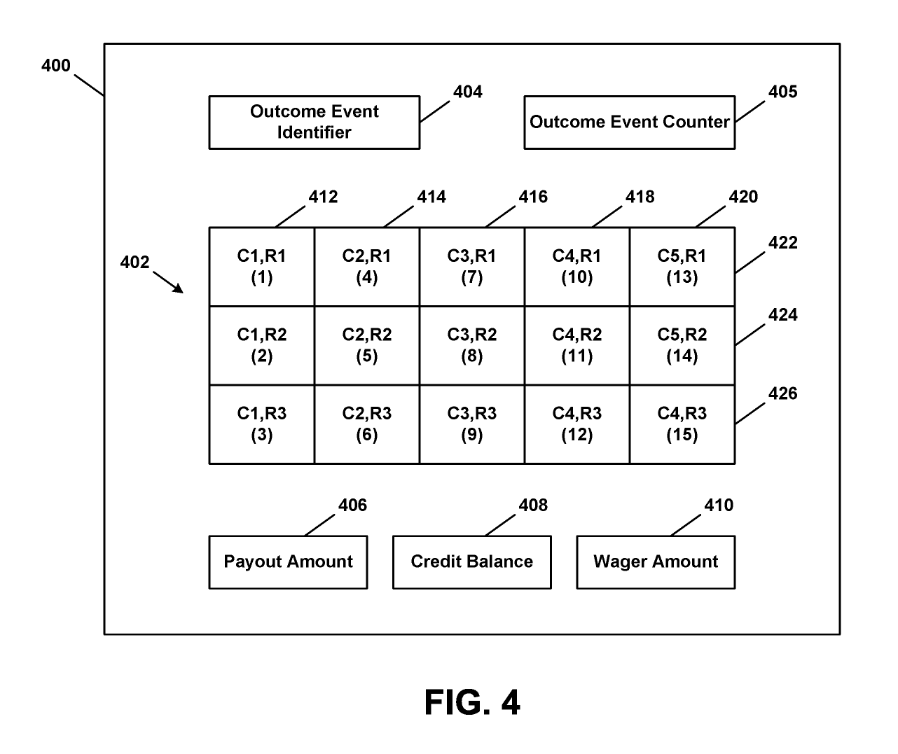

FIG. 4 depicts a screenshot 400 that machine 100, server machine 100a, or client machine 100b can visually present (i.e., display) using displays 110, 110a, and 110b, respectively. For purposes of this description, each element of screenshot 400 can be a displayable element of the display. Screenshot 400 includes a symbol-display-portion 402, an outcome event identifier 404, an outcome event counter 405, a payout amount indicator 406, a credit balance indicator 408, and a wager amount indicator 410.

Symbol-display-portion 402 can include multiple symbol-display-segments and multiple symbol positions. As an example, the symbol-display-segments can include vertical symbol-display-segments 412, 414, 416, 418, and 420 (or more simply, vertical SDSs 412-420). As another example, the symbol-display-segments can include horizontal symbol-display-segments 422, 424, and 426 (or more simply, horizontal SDSs 422-426). Each symbol-display-segment can include multiple symbol positions. The vertical SDSs 412-420 are shown in FIG. 4 as having three symbol positions. The horizontal SDSs 422-426 are shown in FIG. 4 as having five symbol positions. A person skilled in the art will understand that those symbol-display-segments can be configured with different numbers of symbol positions than shown in FIG. 4.

The vertical SDSs 412-420 can be configured as spinnable reels. The processor of a machine or system displaying screenshot 400 can display the spinnable reels spinning and stopped after spinning. For vertical SDSs 412-420, the spinnable reels may spin in a vertical direction (e.g., top to bottom or bottom to top, with respect to the symbol-display-portion 402).

The horizontal SDSs 422-426 can be configured as spinnable reels. The processor of a machine or system displaying screenshot 400 can display the spinnable reels spinning and stopped after spinning. For horizontal SDSs 422-426, the spinnable reels may spin in a horizontal direction (e.g., left to right or right to left, with respect to the symbol-display-portion 402).

Machine 100 can cause symbol-display-segments to spin, and to cause spinning symbol-display-segments to stop spinning. The spinning and stopping of the spinning symbol-display-segments can be carried out for each outcome event. In accordance with the embodiments in which the symbol-display-portion 402 includes columns or reels that spin from top to bottom or bottom to top, spinning the reels can include starting the spinning from a left-most column or reel to a right-most column or reel. Stopping the reels can occur using a similar sequence. Other sequences of spinning and stopping the spinning can be used. Moreover, the spinning or stopping of spinning of two or more columns or reels could occur simultaneously.

The multiple symbol positions in symbol-display-portion 402 are identified by column and row designators, in which C1=column 1, C2=column 2, C3=column 3, C4=column 4, C5=column 5, R1=row 1, R2=row 2, and R3=row 3. The multiple symbol positions in symbol-display-portion 402 are also identified by distinct numerical identifiers shown within parenthesis. C1 can be a first SDS. C2 can be a second SDS. C3 can be a third SDS. C4 can be a fourth SDS. C5 can be a fifth SDS. As shown in FIG. 4, C2 is between C1 and C3, C3 is between C2 and C4, and C4 is between C3 and C5.

For a matrix arrangement with 15 symbol positions as shown in FIG. 4, the numerical identifiers can be whole numbers 1 through 15, inclusive. The processors or machines described herein can be configured to select a symbol position of symbol-display-portion 402 using a random number generator that is configured to generate a number within the range 1 through N, inclusive, where N equals the number of symbol positions in symbol-display-portion 402. For the matrix arrangement, each symbol-display-segment can be a distinct column of the multiple columns within the matrix. Alternatively, for the matrix arrangement, each symbol-display-segment can be a distinct row of the multiple rows within the matrix.

The processor of the machines or systems described herein can determine a state the machine or system is operating in or an outcome event that can occur during the determined state of the machine or system. In response to making that determination, the processor can cause the outcome event identifier 404 to display an identifier of the outcome event that can occur during the determined state. For example, the outcome event identifier can identify a base outcome event, a bonus outcome event or another type of outcome event. The bonus outcome event can be a “free spins” outcome event or some other outcome event.

The processor of the machines or systems described herein can determine a wager amount placed on an outcome event, a payout amount after or during occurrence of an outcome event resulting in a win, a credit balance after or while decreasing a number of credits based on placement of a wager or after or while increasing a number of credits based on a determined payout amount, and a number of awarded remaining outcome events that can occur. The processor can cause the determined wager amount to be displayed by the wager amount indicator 410, the determined payout amount to be displayed by the payout amount indicator 406, the determined credit balance to be displayed by the credit balance indicator 408, and the number of awarded remaining outcome events to be displayed by the outcome event counter 405.

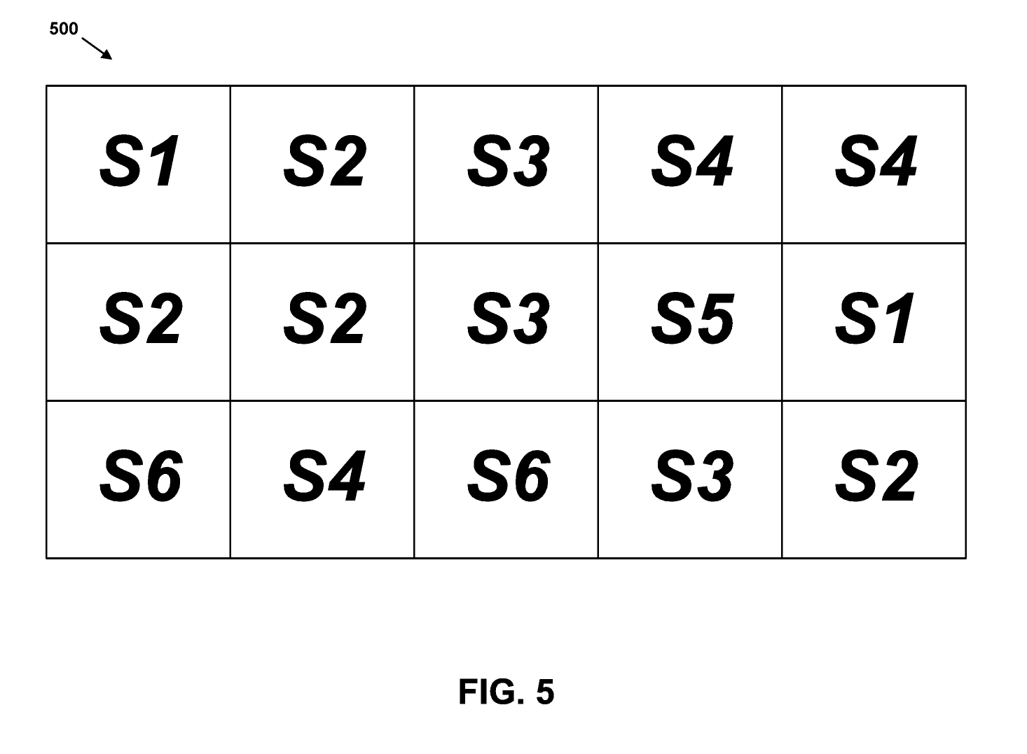

FIG. 5 shows an example of a selected symbol set 500 from the global symbol group for display during a base or bonus outcome event. The selected symbol set 500 includes (i) symbol S1 at arrangement positions C1,R1 and C5,R2, (ii) symbol S2 at arrangement positions C2,R1, C1,R2, C2,R2, and C5,R3, (iii) symbol S3 at arrangement positions C3,R1, C3,R2, and C4,R3, (iv) symbol S4 at arrangement positions C4,R1, C5,R1, and C2,R3, (v) symbol S5 at arrangement position C4,R2, and (vi) symbol S6 at arrangement positions C1,R3 and C3,R3. Other arrangements of symbols, in terms of the number of columns, number of rows, or the layout of symbols, are possible.

### III. Example Reel-Based Bonus Game

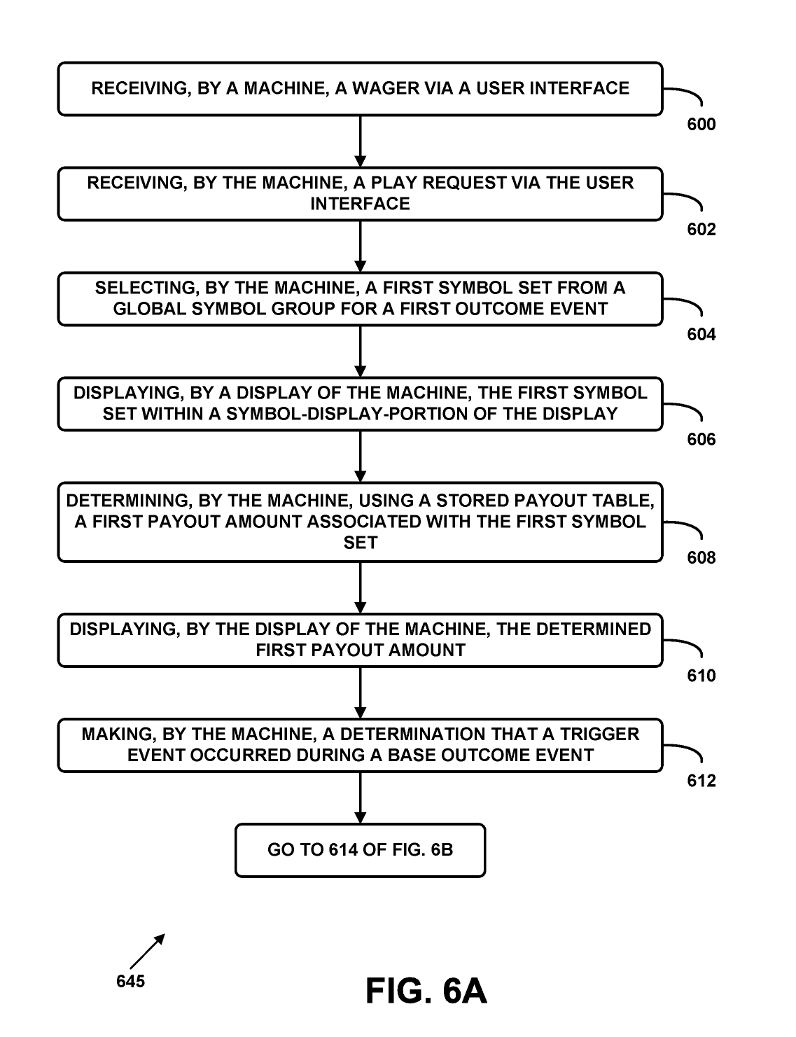

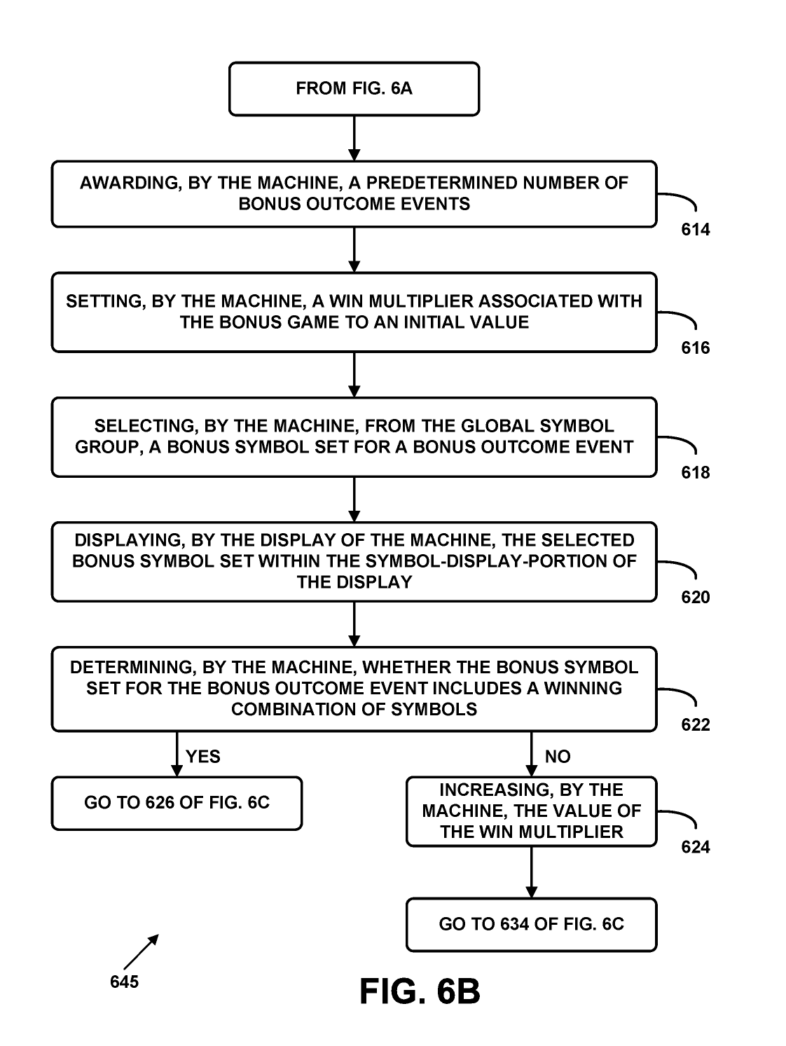

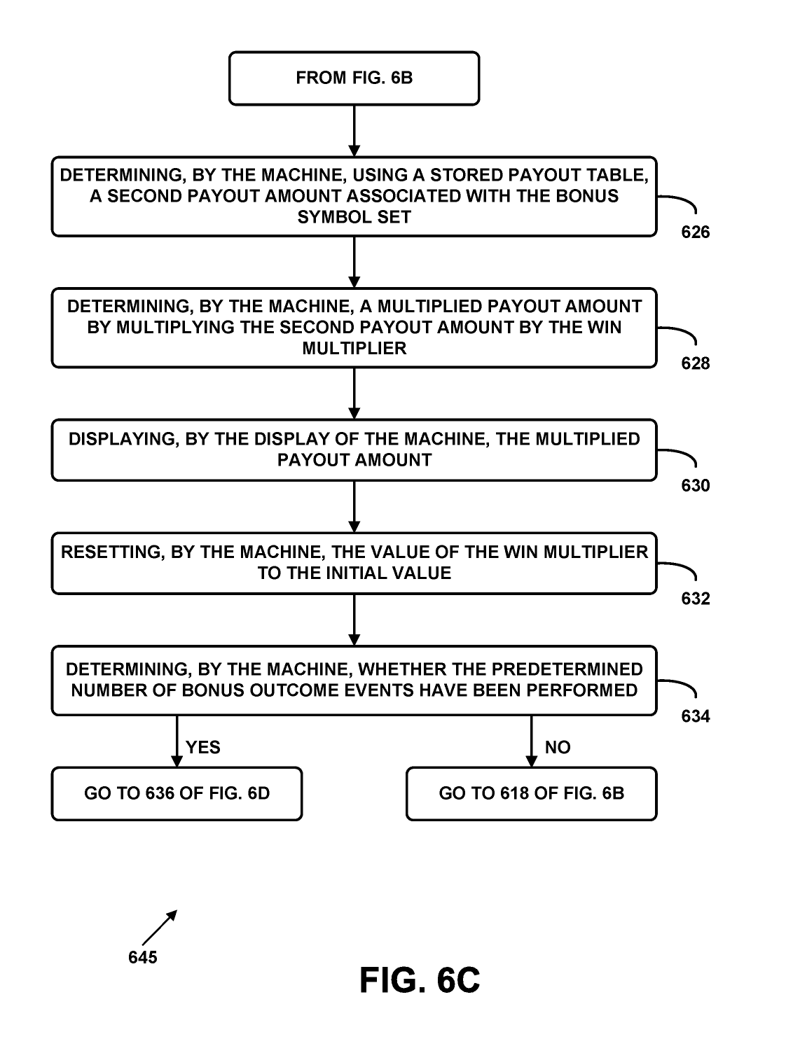

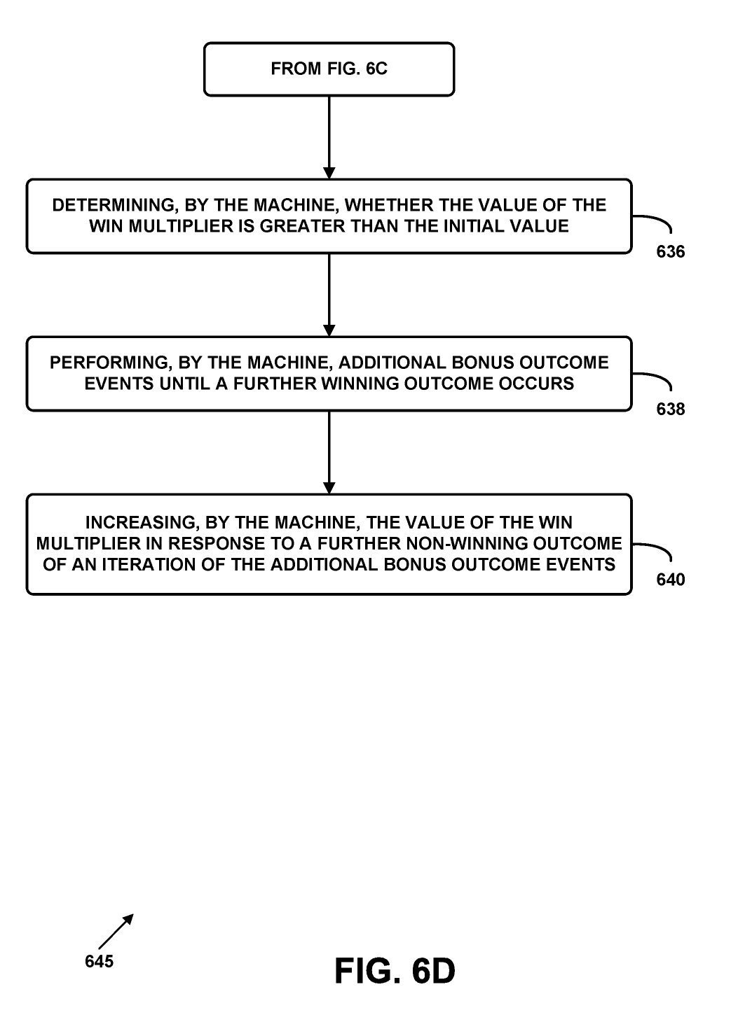

FIG. 6A, FIG. 6B, FIG. 6C, and FIG. 6D (i.e., FIGS. 6A-6D) depict a flow chart showing a set of operations 645 (or more simply, “the set 645”) that can, for example, be carried out using machine 100. Nonetheless, some or all of these operations may be carried out on server machine 100a and/or client machine 100b.

The operations of the set 645 are shown within blocks labeled with even integers between 600 and 640, inclusive, and can pertain to a method in connection with machine 100. The example method can relate to performing outcome events, such as a wager game. Any other operation(s) described herein as being performed by machine 100 can be performed prior to, while, or after performing any one or more of the operations of the set 645, unless context clearly dictates otherwise. Those other operation(s) can be performed in combination with or separately from any one or more of the operations of the set 645. Any operation described below, or elsewhere in this description, with respect to FIGS. 6A, 6B, 6C, and 6D, can be performed, at least in part, by a processor, such as processor 112 executing software program instructions.

Turning to FIG. 6A, block 600 includes receiving, by machine 100, a wager via the user interface 104. In one example, this may allow a player to enter a wager (e.g., a wager amount) using a keypad of the user interface 104. The wager can be placed on an outcome event, such as, but not limited to, a base outcome event configured as a wager game. The received wager may or may not provide a user of the machine with an opportunity to earn (e.g., win) a payout. Since a received wager does not necessarily provide an opportunity to earn a payout, the received wager can be referred to as a payment. A base outcome event can be carried out after or in response to receiving a payment. Machine 100 can be configured such that a bonus outcome event can be carried out without receiving any additional payment after receiving a payment to carry out a base outcome event that results in an award of a predetermined number of bonus outcome events.

A player using machine 100 may have a corresponding player credit balance from which the entered wager may be deducted in response to the wager being entered or machine 100 receiving a play request from the player. For example, a player may have a player credit balance of 100,000 credits, which may be reduced to 99,750 credits upon the player requesting a play of the game with a wager of 250 credits. Additionally, or alternatively, the wager can be received by entry of a token, coin, or paper bill into the user interface 104 or by sliding or inserting a payment card, such as a credit or debit card, into the user interface 104. Machine 100 can cause display 110 to display wager information such as, but not limited to, a player credit balance on the credit balance indicator 408, possible wager amounts in wager amount indicator 410, and a received wager amount in wager amount indicator 410.

Next, block 602 includes receiving, by machine 100, a play request (e.g., a “spin” request) via the user interface 104. Receiving the play request may involve or allow a player to pull a lever or push a button on machine 100 to initiate occurrence of an outcome event or to request a play of the wager game. Receiving the play request can result in the player's credit balance being reduced by an amount of the player's wager or payment to carry out the outcome event.

Next, block 604 includes selecting, by machine 100, a first symbol set to display within the symbol-display-portion 402 of display 110 for the outcome event. Determining the first symbol set can include processor 112 carrying out a random selection, such as a random selection of the first symbol set from a global symbol group, as described with respect to FIG. 3.

Next, block 606 includes displaying, by the machine 100 on the symbol-display-portion of the display 110, the selected first symbol set. FIG. 5 shows an example of a first symbol set 500 from the global symbol group for display during a base outcome event.

Next, block 608 includes determining, by machine 100, using a stored payout table (not shown), a first payout amount, where the first payout amount is a function of the selected first symbol set and the received wager. Processor 112 can execute program instructions to determine whether a payout is earned (e.g., won) as a result of each outcome event occurring at machine 100. If a payout is not earned, the payout amount can be zero. If a payout is earned, the payout amount can be a function of the received wager and the symbol set selected for the outcome event (e.g., the first symbol set selected for the first outcome event) or the corresponding arrangements of symbols in the selected first symbol set.

Next, block 610, includes displaying, by display 110 of machine 100, the determined first payout amount. For example, where machine 100 has determined, using the stored payout table, a first payout amount of 500 credits, machine 100 may display on display 110 the determined payout amount of 500 credits. Additionally or alternatively, machine 100 may add the determined payout amount to the player credit balance and display the updated player credit balance. For instance, where the player credit balance was 99,750 credits before the payout amount was determined, machine 100 may add the determined payout amount of 500 credits to the player credit balance so that the updated balance is 100,250 credits. Furthermore, machine 100 can cause display 110 to display a count-up from a first balance amount (e.g., 99,750 credits) to a second balance amount (e.g., 100,250 credits), where the second balance amount equals a sum of the first balance amount and the determined payout amount.

Next, block 612 includes making, by machine 100, a determination that a trigger event occurred during the base outcome event. The trigger event can be a randomly occurring event, such as an event that randomly occurs during performance of at least some base outcome events. For example, occurrence of the trigger event can include the presence of at least one trigger symbol in the first symbol set, such as in connection with a previous play of the game (e.g., a base outcome event). Similar to the selection of the first symbol set, in one example, machine 100 may use a random number generator to select the trigger symbol from the global symbol group. In another example, the trigger symbol may be non-randomly selected, such as selected by a user (e.g. a player, machine designer or casino personnel). In another example, the trigger symbol may be predetermined, for example a WILD symbol.

Making the determination that the trigger event occurred can take place while machine 100 operates in a first machine state (or more simply, the first state). Machine 100 can be configured such that, while machine 100 is operating in the first state, machine 100 allows the player to play base outcome events in which sets of symbols selected from a global symbol group can be selected by processor 112 and displayed by display 110.

Turning to FIG. 6B, block 614 includes, responsive to machine 100 making the determination (i.e., the determination made at block 612), awarding, by machine 100, a bonus feature of the game. For example, the bonus feature may be a predetermined number of consecutive plays (e.g., spins and/or patterns of symbols being displayed) of outcome events. The awarded outcome events can be bonus outcome events, such as a game or a wager game. The predetermined number of consecutive outcome events can be conditioned upon a combination of symbols displayed by display 110 as a result of playing a base outcome event. Machine 100 can cause outcome event identifier 404 to identify the bonus outcome event awarded (e.g., a “free spins” bonus) and to cause the outcome event counter 405 to display the predetermined number.

Furthermore, in response to making the determination at block 612, machine 100 can transition from operating in the first state to operating in a second machine state (or more simply, the second state). Machine 100 can be configured such that, while machine 100 is operating in the second state, machine 100 allows the player to play bonus outcome events in which sets of symbols selected from a global symbol group can be selected by processor 112 and displayed by display 110. In accordance with an embodiment in which the symbol-display-portion includes 15 symbol positions, selecting a set of symbols for a bonus outcome event can include selecting 15 symbols.

Machine 100 can be configured to transition from operating in the second state back to operating in the first state. This transition can occur in response to machine 100 determining any of a variety of trigger events, such as, but not limited to, occurrence of all of the awarded predetermined number of consecutive plays of the outcome event, or a player stopping play of machine 100 while one or more of the awarded predetermined number of consecutive plays of the outcome event remain to occur. Machine 100 can be configured to store a number indicating any remaining consecutive plays of the outcome event and to allow a player awarded the consecutive plays to commence playing any remaining consecutive plays of the outcome event at a time after the player stops performing (e.g., playing) the outcome events.

Next, block 616 includes setting, by the machine 100, a win multiplier associated with the bonus game to an initial value. The win multiplier may be a value by which payout amounts associated with winning outcomes (e.g., winning combinations of symbols) of the bonus outcome events are multiplied.

The win multiplier may take on a plurality of values, ranging from the initial value to a maximum value. In one embodiment, the initial value may be 2, the maximum value may be 7, and the plurality of values may include the values 2, 3, 4, 5, 6, and 7. In alternative embodiments, the plurality of candidate values of the win multiplier may be different (e.g., the plurality of values may include 1, 2, 4, 8, and 16). The win multiplier may be stored in data storage 114 in the form of a counter. Setting the win multiplier to the initial value may include writing, by processor 112, the initial value to the counter in data storage 114.

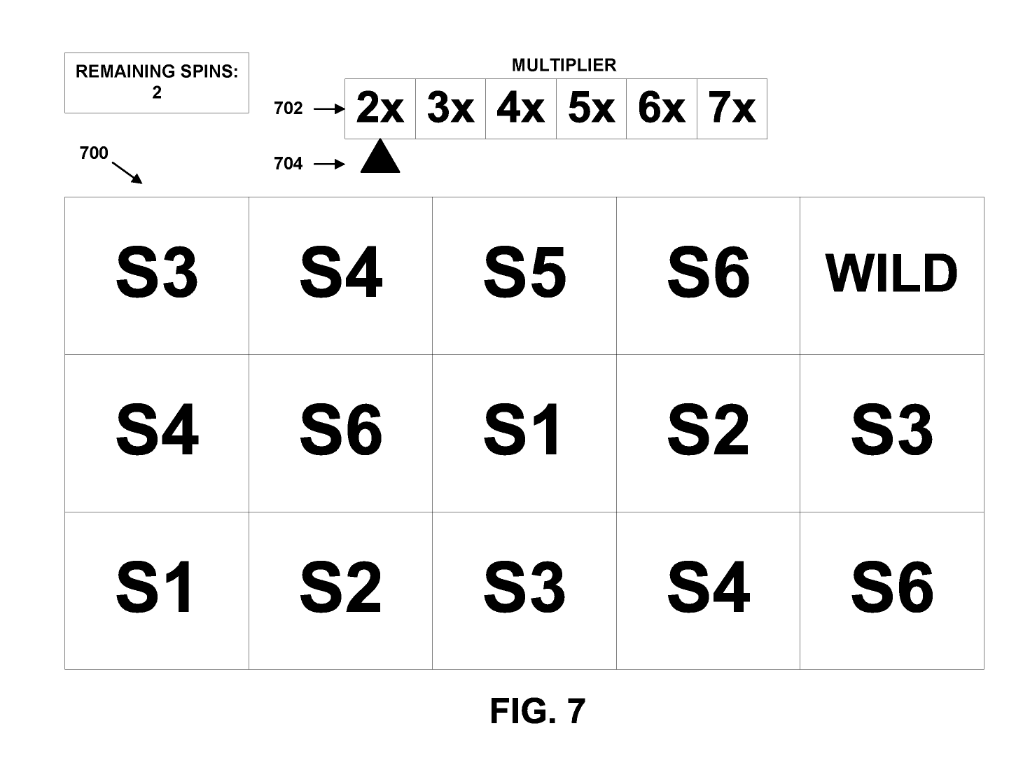

The current value of the win multiplier may be displayed by display 110 above the symbol-display-portion 402, as illustrated in FIG. 7. Display 110 of machine 100 may display all of the values 702 that the win multiplier may take on (e.g., 2×, 3×, 4×, 5×, 6×, and 7×). Visual indicator 704 may be used to indicate the current value of the win multiplier (e.g., 2×).

Next, block 618 includes selecting, by the machine 100 from the global symbol group, a bonus symbol set for a bonus outcome event.

Next, block 620 includes displaying, by the machine 100 on the symbol-display-portion of the display 110, the selected bonus symbol set. FIG. 7 shows an example of such a bonus symbol set 700 selected from the global symbol group. The bonus symbol set 700 consists of (i) one WILD symbol at arrangement position C5,R1; (ii) two S1 symbols at arrangement positions C1,R3 and C3,R2; (iii) two S2 symbols at arrangement positions C2,R3 and C4,R2; (iv) three S3 symbols at arrangement positions C1,R1, C3,R3, and C5,R2; (v) three S4 symbols at arrangement positions C1,R2, C2,R1, and C4,R3; (vi) one S5 symbol at arrangement position C3,R1; and (vi) three S6 symbols at arrangement positions C2,R2, C4,R1, and C5,R3.

Next, block 622 includes determining, by the machine 100, whether the bonus symbol set for the bonus outcome event includes a winning combination of symbols. In that regard, processor 112 may determine, for example, that a number of instances of a particular symbol are arranged in a predetermined pattern that constitutes a winning combination. For example, processor 112 may determine that the instances of the particular symbol are located along a pay line.

Next, block 624 includes increasing, by the machine 100, the value of the win multiplier when the bonus symbol set for the bonus outcome event does not include a winning combination of symbols. In that regard, processor 112 may increase the value of the counter stored in data storage 114 and representing the current value of the win multiplier. Processor 112 may first check whether the current value of the win multiplier is at the maximum value. Processor 112 may increase the win multiplier value when the current win multiplier value is not at the maximum value. When the current win multiplier value is at the maximum value, the win multiplier value may remain unchanged.

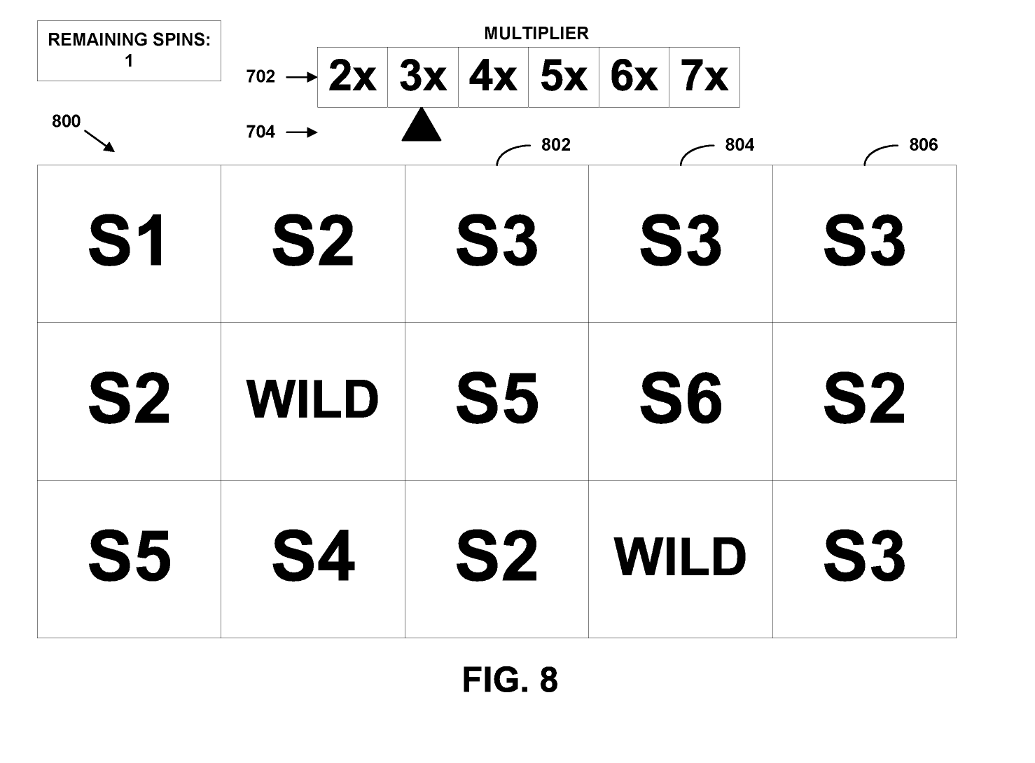

For example, the value of the win multiplier may be increased from 2, as illustrated in FIG. 7, to 3, as illustrated in FIG. 8, when the bonus symbol set 700 does not include a winning symbol combination. Thus, the gaming machine may provide an incentive or non-monetary reward in the form of the increased win multiplier in response to non-winning symbol combinations. Accordingly, non-winning symbol combinations may contribute to payout amounts associated with future winning bonus outcome events. Once the win multiplier is increased, control flow may proceed to block 634 which is described below.

The example bonus symbol sets illustrated herein are described as including winning or non-winning symbol combinations for the sake of example. It is to be understood that the particular bonus symbol sets herein described as including a non-winning symbol combination may, in some implementations, actually include a winning symbol combination. Likewise, the particular bonus symbol sets herein described as including a winning symbol combination may, in some implementations, actually be a non-winning symbol combination.

Turning to FIG. 6C, block 626 includes determining, by the machine 100, a second payout amount when the bonus symbol set for the bonus outcome event includes a winning combination of symbols. In one example, the second payout amount may be determined by the machine 100 using a stored payout table (not shown) as a function of the received wager and the symbols in the displayed bonus symbol set. Specifically, the second payout amount may be based on values within the stored payout table corresponding to the symbols in the winning combination of symbols.

Next, block 628 may include determining, by the machine 100, a multiplied payout amount by multiplying the second payout amount by the win multiplier. In that regard, processor 112 may retrieve, from data storage 114, the value of the counter representing the current value of the win multiplier. Processor 112 may then multiply the second payout amount determined in block 626 by the current value of the win multiplier to determine a multiplied payout amount that is to be payed out by the machine 100.

Next, block 630 includes displaying, on the display 110 of machine 100, the determined multiplied payout amount. In one example, the machine 100 may also physically dispense a corresponding payout amount (e.g., cash), or otherwise facilitate the payout to the player (e.g., by adding funds to an electronic account associated with a gaming card).

Next, block 632 includes, resetting, by the machine 100, the value of the win multiplier to the initial value. The value of the win multiplier may be reset to the initial value when the bonus symbol set for the bonus outcome event includes a winning combination of symbols. In that regard, processor 112 may write the initial value to the counter in data storage 114 storing the value of the win multiplier.

Next, block 634 includes determining, by the machine 100, whether the predetermined number of bonus outcome events have been performed. This determination may be made regardless of whether the bonus outcome event includes a winning or non-winning symbol combination. In that regard, processor 112 may determine that one or more awarded bonus outcome events have not occurred by referring to data within data storage 114 that is displayed at bonus outcome event counter 405 shown in FIG. 4. An awarded bonus outcome event that has not yet occurred can be referred to as a “remaining bonus outcome event.”

When one or more awarded bonus outcome events have not occurred, machine 100 may initiate a remaining bonus outcome event by following control flow of operations 645 from block 634 to block 618.

Turning to FIG. 6D, block 636 includes determining, by the machine 100, whether the value of the win multiplier is greater than the initial value. In that regard, processor 112 may retrieve, from data storage 114, the value of the counter representing the current value of the win multiplier. The current value of the multiplier may be compared to the initial value to determine whether the current value is greater than the initial value.

Next, block 638 includes performing, by the machine 100, additional bonus outcome events until a further winning outcome event occurs.

Next, block 640 may include increasing, by the machine 100, the value of the win multiplier in response to a further non-winning outcome of an iteration of the additional bonus outcome events.

Performing additional bonus outcome events may include following the control flow of operations 645 from block 618 to block 630. Thus, the operations of block 640 may be similar or equivalent to the operations of block 624 and may follow a similar control flow.

In some embodiments, the additional bonus outcome events may be performed in response to determining that the values of the win multiplier is greater than the initial value. Thus, when the win multiplier is accumulated to a value greater than the initial value during a last iteration of the predetermined number of bonus outcome events, the win multiplier might not be “wasted” by termination of the bonus game. Instead, additional bonus outcome events may be performed until a winning outcome event occurs and the win multiplier is used to multiply the payout amount of the winning outcome event.

Alternatively, in some embodiments, the operations of block 636 may be omitted. That is, additional bonus outcome events may be performed in block 638 regardless of the value of the win multiplier during the last iteration of the predetermined number of bonus outcome events. Thus, the machine 100 may be guaranteed to provide at least one additional bonus outcome event in addition to the predetermined number of bonus outcome events. In either embodiment, the machine 100 may guarantee at least one winning bonus outcome event as a result of the operations of set 645.

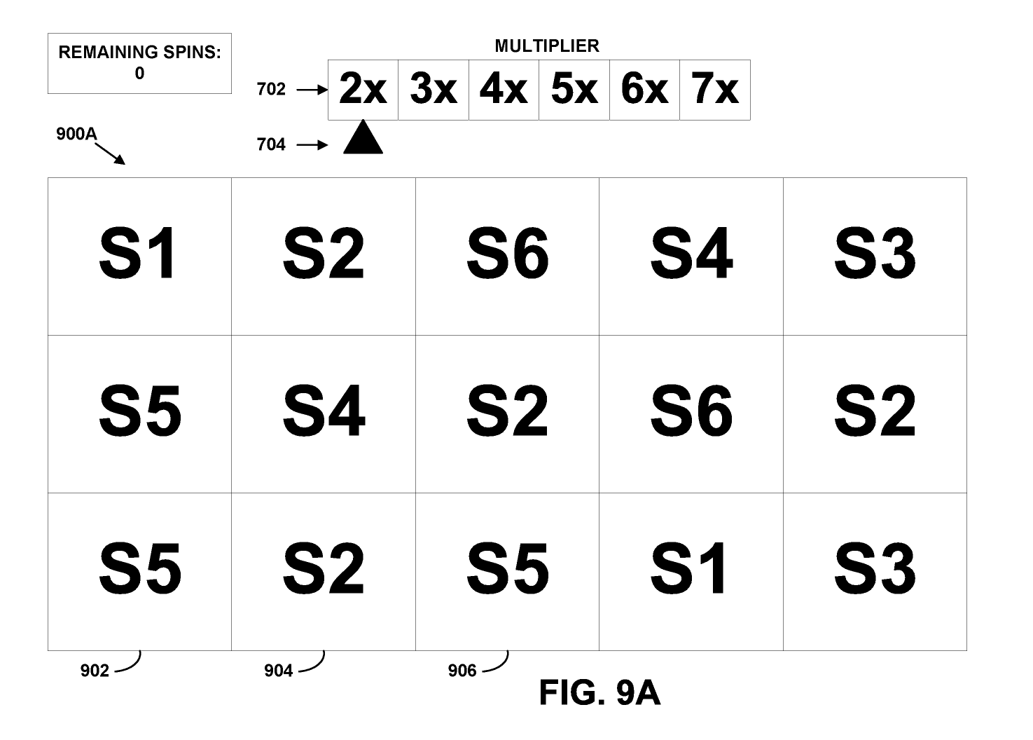

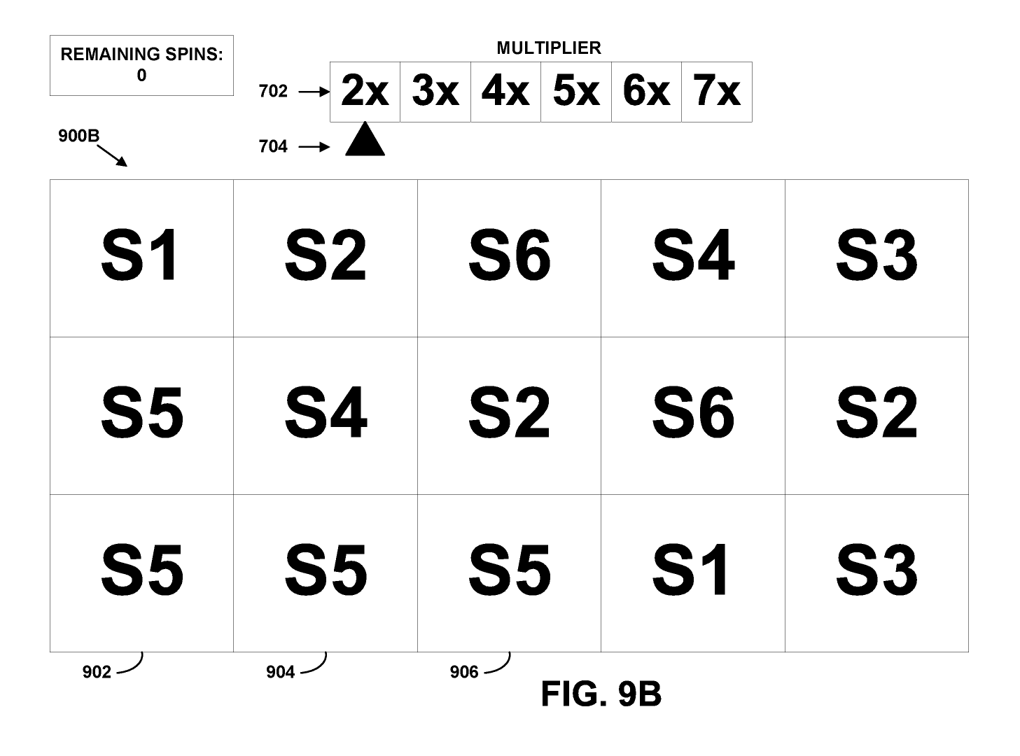

FIG. 7, FIG. 8, FIG. 9A, and FIG. 9B illustrate the operations of set 645 in more detail. In particular, as described above, FIG. 7 may represent an outcome of a first iteration of a predetermined number of bonus game outcomes. Win multiplier 702 may be set to an initial value of 2 before the first spin is carried out. In the illustrated example, the predetermined number may be equal to 3. FIG. 7 indicates that the bonus game includes 2 remaining spins since outcome 700 of the first spin has already been determined.

It may be determined that the bonus symbol set 700 does not include a winning symbol combination. Accordingly, the value of the win multiplier may be increased from 2 to 3, as illustrated in FIG. 8. A second symbol set 800 may be selected. The bonus symbol set 800 consists of (i) two WILD symbols at arrangement position C2,R2 and C4,R3; (ii) one S1 symbol at arrangement position C1,R1; (iii) four S2 symbols at arrangement positions C1,R2, C2,R1, C3,R3, and C5,R2; (iv) four S3 symbols at arrangement positions C3,R1, C4,R1, C5,R1, and C5,R3; (v) one S4 symbol at arrangement position C2,R3; (vi) two S5 symbols at arrangement positions C1,R3 and C3,R2; and (vi) one S6 symbol at arrangement position C4,R2.

The bonus symbol set 800 may include at least one winning symbol combination. In particular, symbols 802, 804, and 806 may form part of an example winning symbol combination of three S3 symbols in a row. As discussed above, other winning combinations may be possible within the symbol set 800, and the winning combination of symbols 802, 804, and 806 is provided for illustrative purposes only. The payout amount associated with the winning combination of three S3 symbols in a row may be multiplied by the value of the win multiplier, namely the value 3. Thus, if three S3 symbols in a row are associated with a payout amount of 100 credits, the multiplied payout amount may be equal to 300 credits. The winning combination of three S3 symbols in a row in symbol set 800 may cause the win multiplier to be reset to the initial value of 2, as illustrated in FIG. 9A.

FIG. 9A shows a further example of another bonus symbol set 900A selected from the global symbol group for displaying during a remaining bonus outcome event. The example symbol set 900A represents a first possible outcome event of a last iteration of the bonus game, as indicated by the zero remaining spins. Symbol set 900A does not include a winning symbol combination. Thus, the value of win multiplier 702 may be incremented from 2 to 3. Accordingly, since the win multiplier value is not equal to the initial value, additional bonus game outcomes may be awarded. The additional bonus game outcomes may be played until a winning outcome occurs, with the value of the win multiplier being increased in response to non-winning outcomes of the additional bonus game outcomes. In some embodiments, when the value of the win multiplier is at the initial value, the bonus game may end without awarding the additional bonus game outcomes.

FIG. 9B shows a further example of another bonus symbol set 900B selected from the global symbol group for displaying during a remaining bonus outcome event. The example symbol set 900B represents a second possible outcome event of a last iteration of the bonus game, as indicated by the zero remaining spins. Symbols sets 900A and 900B are identical with the exception of position C2,R3.

Notably, FIG. 9B illustrates an embodiment in which the additional bonus game outcomes are performed regardless of the value of the in multiplier following the last iteration of the predetermined number of bonus game events. Symbol set 900B may include at least one winning combination that includes three S5 symbols in a row (i.e., the S5 symbols 902, 904, and 906). Accordingly, the value of the win multiplier may be reset to the initial value and may thus remain at 2. Nevertheless, additional bonus game outcomes may be awarded to be performed after the predetermined number of bonus game outcomes have been performed.

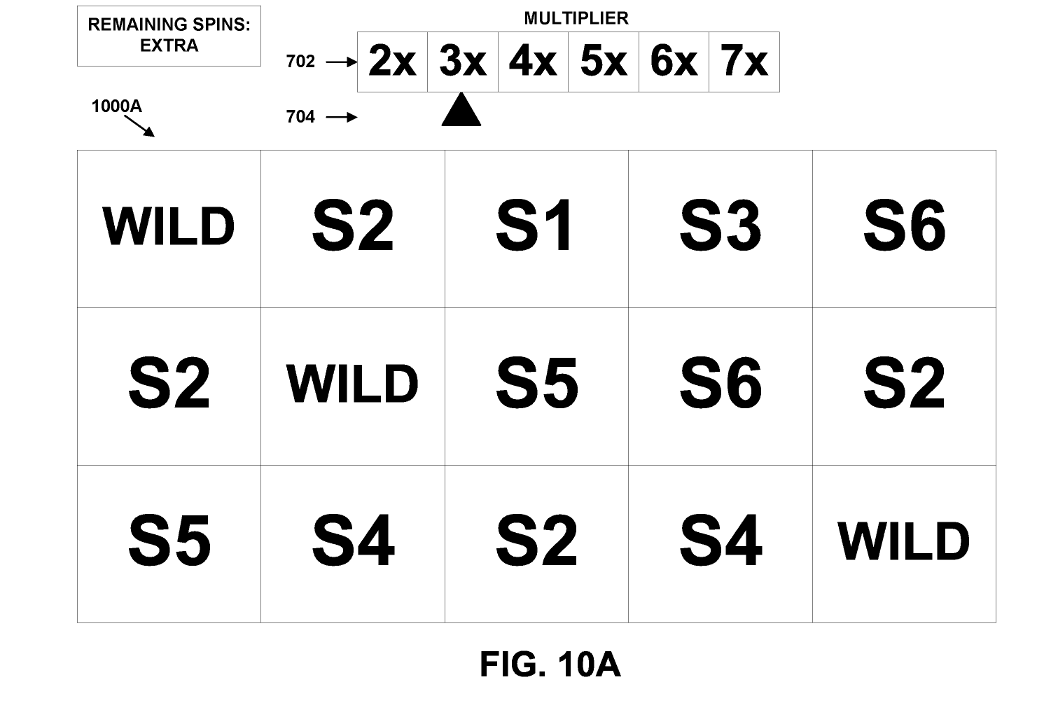

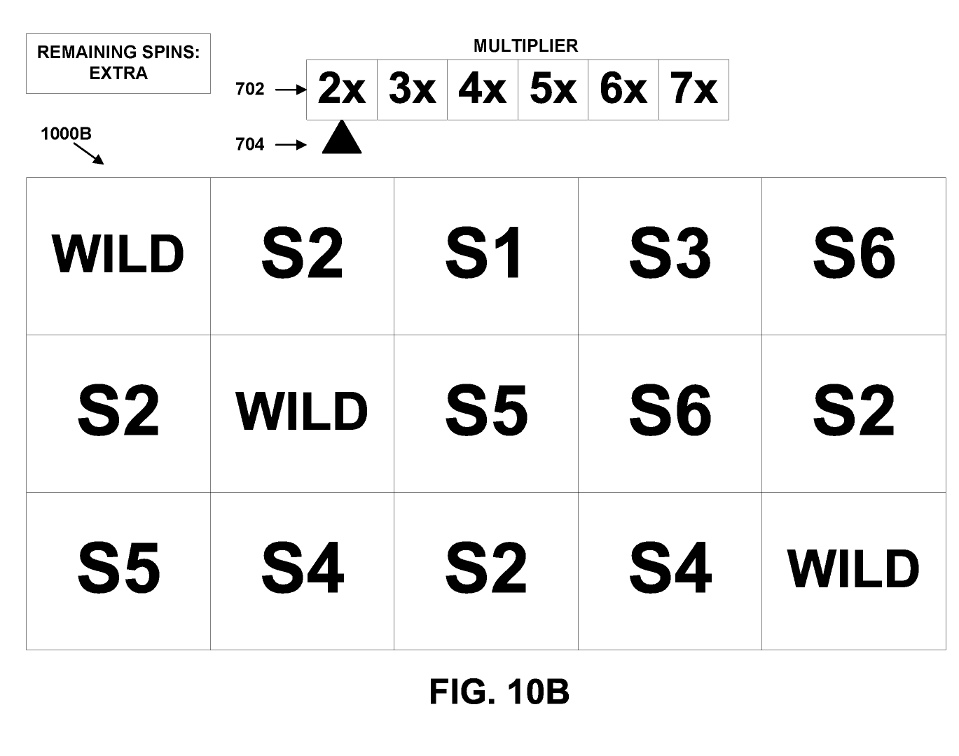

FIG. 10A illustrates an example additional bonus game outcome 1000A following the last iteration of the bonus game illustrated in FIG. 9A. In particular, the value of win multiplier is incremented from 2 to 3 since symbol set 900A did not include a winning symbol combination. Additionally, FIG. 10A shows the number of remaining spins as “EXTRA” to indicate that additional bonus game outcome events beyond the predetermined number of bonus game outcome events are being performed.

Similarly, FIG. 10B illustrates an example additional bonus game outcome 1000B following the last iteration of the bonus game illustrated in FIG. 9B. In particular, the value of win multiplier 702 remains at 2 since symbol set 900A included a winning symbol combination. Additionally, FIG. 10B shows the number of remaining spins as “EXTRA” to indicate that additional bonus game outcome events beyond the predetermined number of bonus game outcome events are being performed. In both FIGS. 10A and 10B, the additional bonus game outcome events may be played in the same manner as the predetermined number of bonus game outcome events. The win multiplier may be increased in response to non-winning outcomes of the additional bonus game outcome events. The additional bonus game outcome events may be terminated when a winning outcome occurs.

### IV. Example Operations

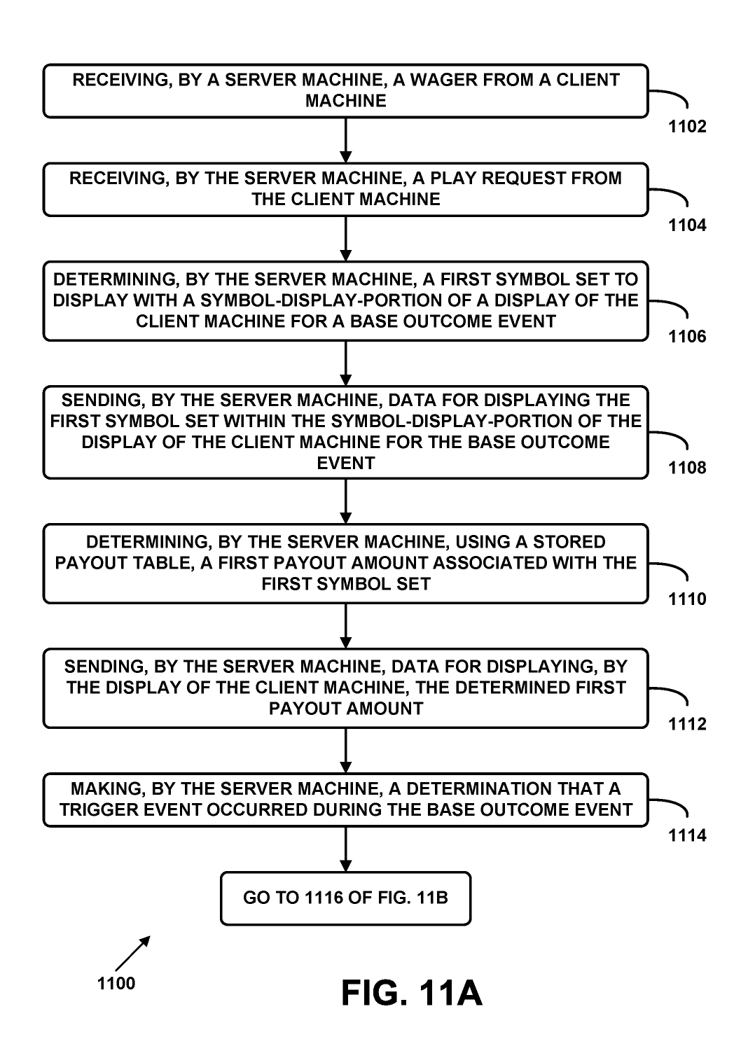

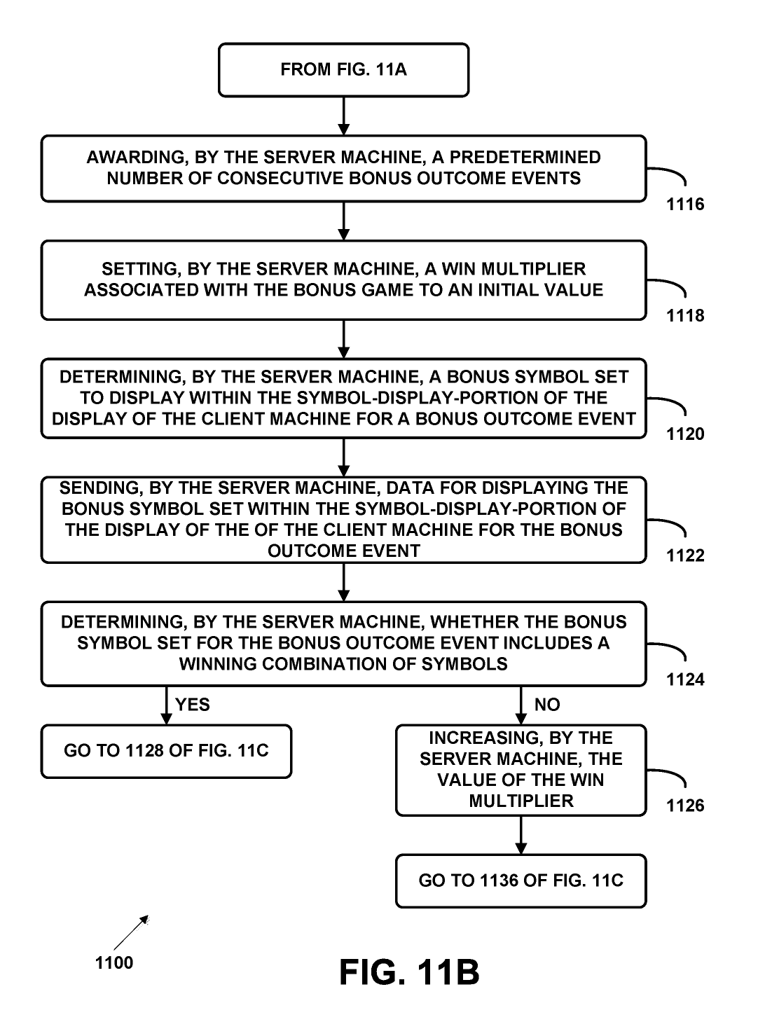

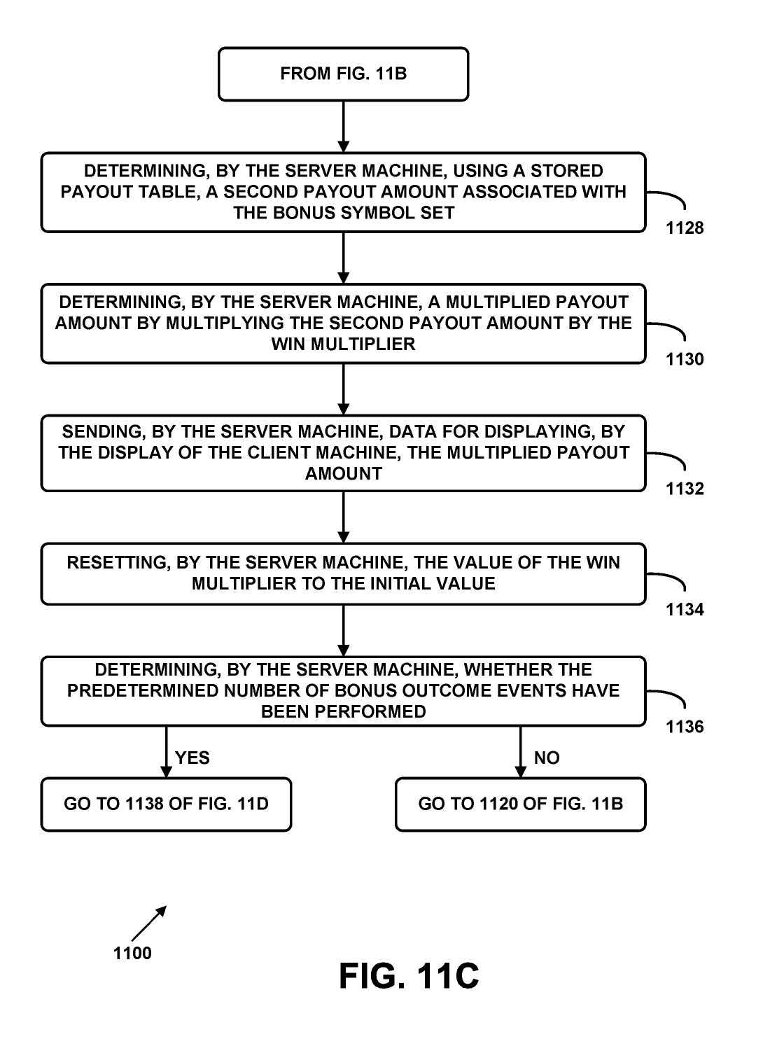

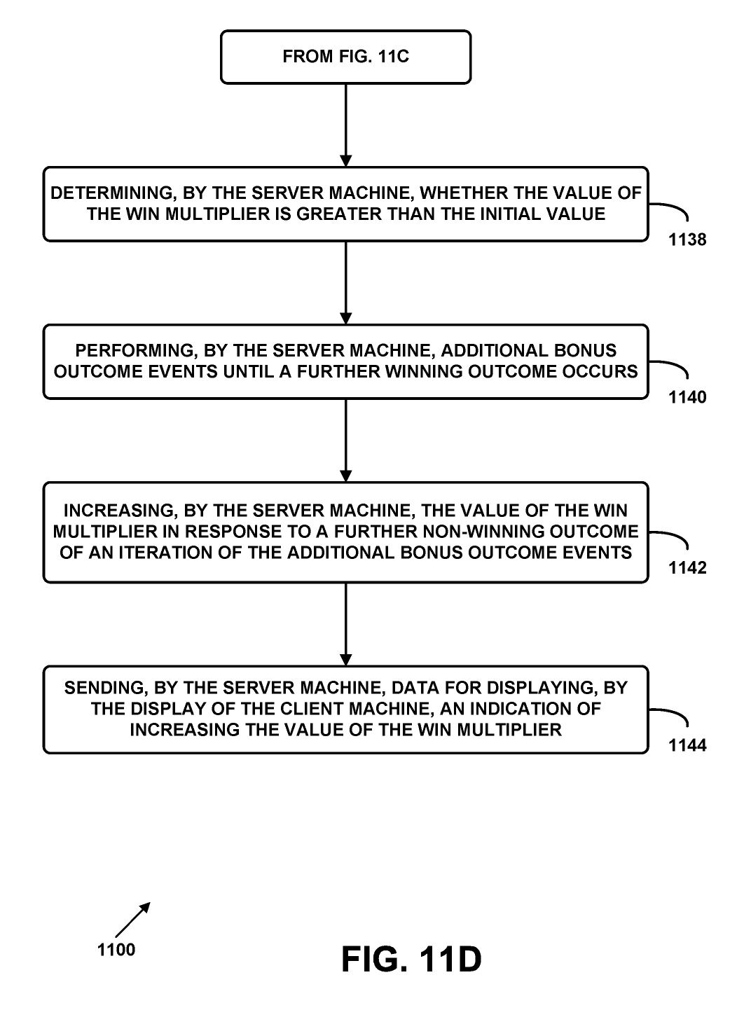

FIGS. 11A-11D depict a flow chart showing a set of operations 1100 (or more simply, “the set 1000”) that can, for example, be carried out using server machine 100a. Note that several of the operations described in connection with FIGS. 11A-11D parallel operations described in connection with FIGS. 6A-6D. As such, variations of the operations described in connection with FIGS. 6A-6D are likewise applicable to the operations described in connection with FIGS. 11A-11D. However, for the sake of brevity, these variations are not repeated. The server machine 100a, in performing the set 1000, can perform the operations described above with respect to machine 100.

Turning to FIG. 11A, block 1102 includes receiving, by the server machine 100a, a wager from the client machine 100b.

Next, block 1104 includes receiving, by the server machine 100a, a play request from the client machine 100b.

Next, block 1106 includes determining, by the server machine 100a, a first symbol set to display within the symbol-display-portion of the display 110b of the client machine 100b for a base outcome event.

Next, block 1108 includes sending, by the server machine 100a, data for displaying, by the display 110b of the client machine 100b, the first symbol set within the symbol-display-portion of the display.

Next, block 1110 includes determining, by the server machine 100a using a stored payout table, a first payout amount associated with the first symbol set.

Next, block 1112 includes sending, by the server machine 100a, data for displaying, by the display 110b of the client machine 100b, the determined first payout amount.

Next, block 1114 includes making, by the server machine 100a, a determination that a trigger event occurred during the base outcome event.

Turning to FIG. 11B, block 1016 includes awarding, by the server machine 100a, a predetermined number of consecutive bonus outcome events.

Next, block 1118 includes setting, by the server machine 100a, a win multiplier associated with the bonus game to an initial value.

Next, block 1120 determining, by the server machine 100a, a bonus symbol set to display within the symbol-display-portion of the display 110b of the client machine 100b for a bonus outcome event.

Next, block 1122 includes sending, by the server machine 100a, data for displaying the bonus symbol set within the symbol-display-portion of the display 110b of the of the client machine 100b for the bonus outcome event.

Next, block 1124 includes determining, by the server machine 100a, whether the bonus symbol set for the bonus outcome event includes a winning combination of symbols.

Next, block 1126 includes increasing, by the server machine 100a, the value of the win multiplier when the bonus symbol set for the bonus outcome event does not include a winning combination of symbols (e.g., the bonus symbol set is a non-winning outcome event). After the value of the win multiplier is increased, control flow may proceed to block 1136, as discussed below.

Turning to FIG. 11C, block 1128 includes determining, by the server machine 100a, using a stored payout table, a second payout amount associated with the bonus symbol set. The second payout amount may be determined when the bonus symbol set for the bonus outcome event includes a winning combination of symbols.

Next, block 1130 includes determining, by the server machine 100a, a multiplied payout amount by multiplying the second payout amount from block 1128 by the win multiplier.

Next, block 1132 includes sending, by the server machine 100a, data for displaying, by the display 110a of the client machine 100b, the multiplied payout amount.

Next, block 1134 includes resetting, by the server machine 100a, the value of the win multiplier to the initial value.

Next, block 1136 includes determining, by the server machine 100a, whether the predetermined number of bonus outcome events have been performed. When the predetermined number of events have not been performed, control flow may proceed to block 1120 to perform a remaining outcome event. That is, control flow may loop through operations 1120-1136 until the predetermined number of outcome events have been performed.

Turning to FIG. 11D, block 1138 may include determining, by the server machine 100a, whether the value of the win multiplier is greater than the initial value. Operations of block 1138 may be performed in response to performance of a last one of the predetermined number of bonus outcome events.

Next, block 1140 includes performing, by the server machine 100a, additional bonus outcome events until a further winning outcome occurs. As discussed above with respect to FIG. 6D, in some embodiments, the additional bonus outcome events may be performed in response to the value of the win multiplier being greater than the initial value upon completion of a last iteration of the predetermined number of bonus outcome events. Alternatively, the additional bonus outcome events may be performed regardless of the win multiplier value upon completion of the last iteration of the predetermined number of bonus outcome events (i.e., the operations of block 1138 may, in some embodiments, be omitted).

Next, block 1142 includes increasing, by the server machine 100a, the value of the win multiplier in response to a further non-winning outcome of an iteration of the additional bonus outcome events.

Next, block 1144 includes sending, by the server machine 100a, data for displaying, by the display 110b of the client machine 100b, an indication of increasing the value of the win multiplier. In some embodiments, all candidate values of the win multiplier may be displayed on display 110b (i.e., all values between and including the initial value and the maximum value). The animation may include changing the color of the previous value of the win multiplier and the new value of the win multiplier to indicate the increasing or resetting of the value of the win multiplier. Additionally or alternatively, in some embodiments, an arrow or other pointer may be moved from the previous value of the win multiplier to the new value of the win multiplier. Other visual animations and indications may be possible.

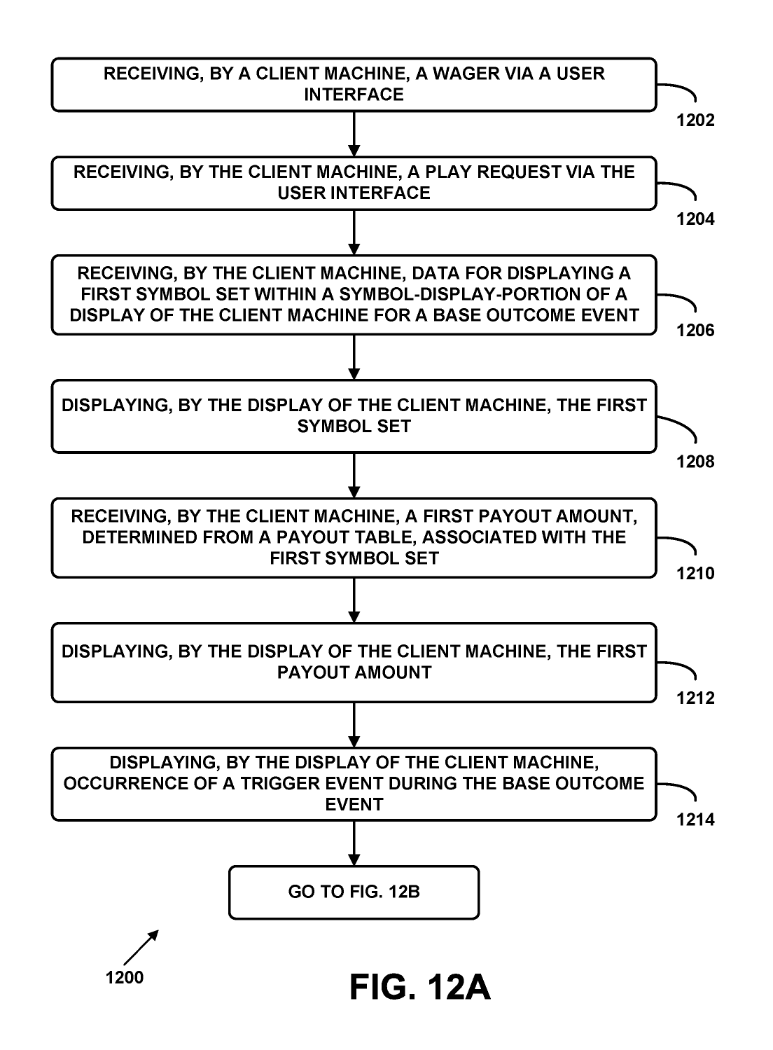

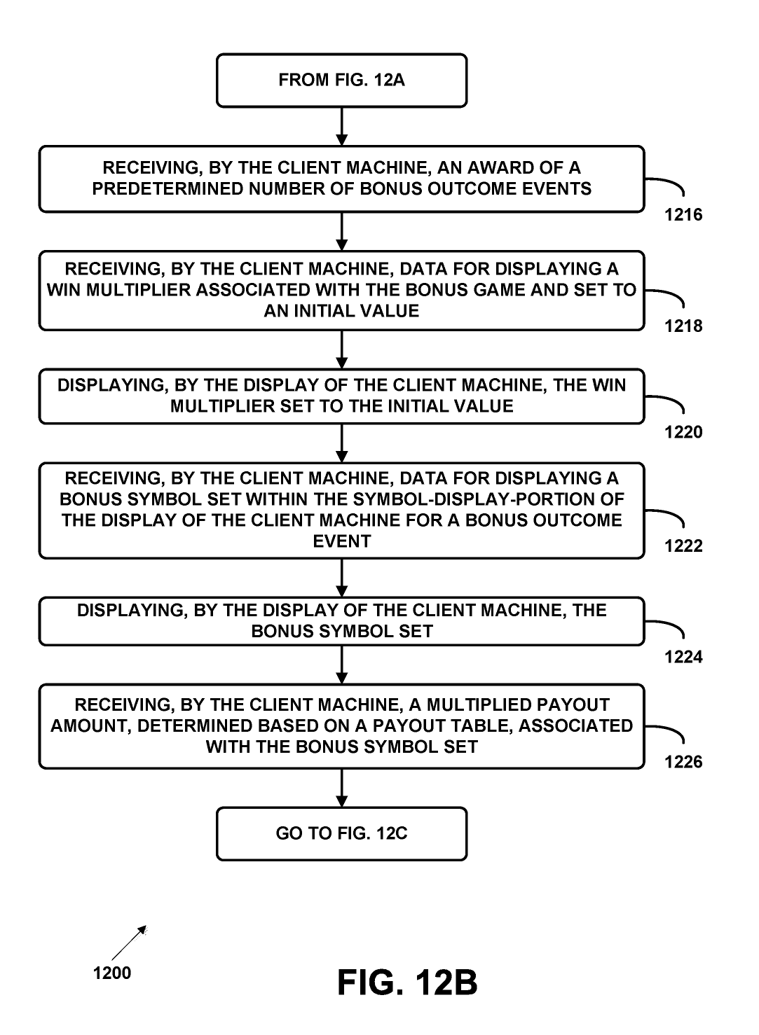

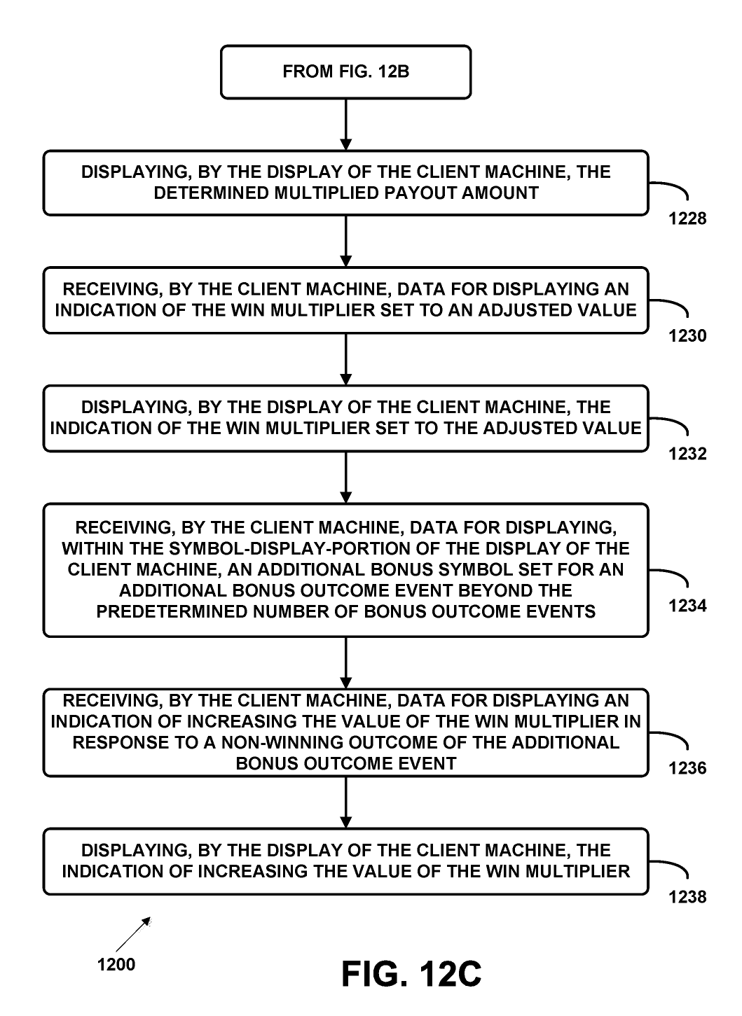

FIGS. 12A-12C depict a flow chart showing a set of operations 1200 (or more simply, “the set 1200”) that can, for example, be carried out using client machine 100b. Note that several of the operations described in connection with FIGS. 12A-12C parallel operations described in connection with FIGS. 6A-6D and FIGS. 11A-11D. As such, variations of the operations described in connection with FIGS. 6A-6D and FIGS. 11A-11D are likewise applicable to the operations described in connection with FIGS. 12A-12C. However, for the sake of brevity, these variations are not repeated. The client machine 100b, in performing the set 1200, can perform the operations described above with respect to machine 100.

Turning to FIG. 12A, block 1202 includes receiving, by the client machine 100b, a wager via the user interface 104b. Client machine 100b can transmit the received wager or data indicative thereof over the communication network 116 to server machine 100a.

Next, block 1204 includes receiving, by the client machine 100b, a play request via the user interface 104b. Client machine 100b can transmit the received play request or data indicative thereof over the communication network 116 to server machine 100a.

Next, block 1206 includes receiving, by the client machine 100b, data for displaying a first symbol set within the symbol-display-portion of the display 110b for a first base outcome event.

Next, block 1208 includes displaying, by the display 100b of the client machine 100b, the first symbol set.

Next, block 1210 includes receiving, by the client machine 100b, a first payout amount, determined from a payout table, associated with the first symbol set.

Next, block 1212 includes displaying, by the display 110b of the client machine 100b, the determined first payout amount.

Next, block 1214 includes displaying, by the display 110b of the client machine 100b, occurrence of a trigger event during the base outcome event.

Turning to FIG. 12B, block 1216 includes receiving, by the client machine 100b, an award of a predetermined number of bonus outcome events.

Next, block 1218 includes receiving, by the client machine 110b, data for displaying a win multiplier associated with the bonus game. The data may indicate that the win multiplier should be set to display an initial value (e.g., 2).

Next, block 1220 includes displaying, by the display 110b of the client machine 100b, the win multiplier set to the initial value.

Next, block 1222 includes receiving, by the client machine 100b, data for displaying a bonus symbol set within the symbol-display-portion of the display of the client machine 100b for a bonus outcome event.

Next, block 1224 includes displaying, by the display 110b of the client machine 100b, the bonus symbol set.

Next, block 1226 includes receiving, by the client machine 100b, a multiplied payout amount, determined based on a payout table, associated with the bonus symbol set. The multiplied payout amount may be determined by multiplying a payout amount associated with the bonus symbol set by the current value of the win multiplier. When the bonus symbol set does not include a winning combination, the multiplied payout amount may be equal to zero. Alternatively, when the bonus symbol set does not include a winning combination and/or when the multiplied payout amount is zero, this operation may be omitted.

Turning to FIG. 12C, block 1228 includes displaying, by the display 110b of the client machine 100b, the determined multiplied payout amount. When the bonus symbol set does not include a winning combination and/or when the multiplied payout amount is zero, this operation may be omitted.

Next, block 1230 includes receiving, by the client machine 100b, data for displaying an indication of the win multiplier set to an adjusted value. The adjusted value may be an increase in the value of the win multiplier responsive to a non-winning outcome of an iteration of the bonus game. Alternatively, the adjustment may include resetting the value of the win multiplier to the initial value responsive to a winning outcome of an iteration of the bonus game.

Next, block 1232 includes displaying, by the display 110b of the client machine 100b, the indication of the win multiplier set to the adjusted value.

Next, block 1234 includes receiving, by the client machine 100b, data for displaying, within the symbol-display-portion of the display 110b of the client machine 100b, an additional bonus symbol set for an additional bonus outcome event beyond the predetermined number of bonus outcome events. The additional bonus symbol set may be displayed responsive to determining that the predetermined number of bonus outcome events have been performed.

Next, block 1236 includes receiving, by the client machine 100b, data for displaying an indication of increasing the value of the win multiplier in response to a non-winning outcome of the additional bonus outcome event. The value may be increased until either a maximum value of the win multiplier is reached or a winning outcome occurs during the additional bonus outcome events.

Next, block 1238 includes displaying, by the display 110b of the client machine 100b, the indication of increasing the value of the win multiplier.

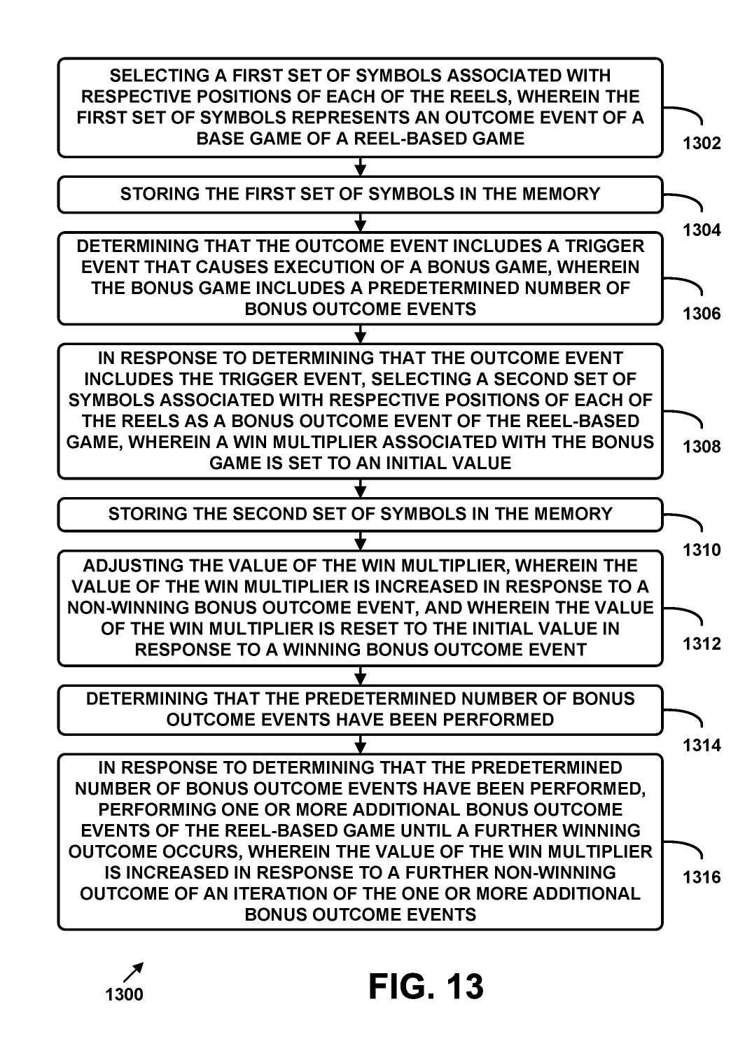

FIG. 13 depicts a flow chart showing a set of operations 1300 (or more simply, “the set 1300”) that can, for example, be carried out using server machine 100a and/or client machine 100b. To the extent that a client machine carries out any of the set 1300, these operations may also include displaying various types of information, such as symbol sets, payout amounts, and so on. Note that several of the operations described in connection with FIG. 13 parallel operations described in connection with FIGS. 6A-6D, FIGS. 11A-11D, and FIGS. 12A-12C. As such, variations of the operations described in connection with FIGS. 6A-6D, FIGS. 11A-11D, and FIGS. 12A-12C are likewise applicable to the operations described in connection with FIG. 13.

Turning to FIG. 13, block 1302 includes selecting a first set of symbols associated with respective positions of each of the reels, wherein the first set of symbols represents an outcome event of a base game of a reel-based game.

Next, block 1304 includes storing the first set of symbols in the memory.

Next, block 1306 includes determining that the outcome event includes a trigger event that causes execution of a bonus game, wherein the bonus game includes a predetermined number of bonus outcome events.

Next, block 1308 includes, responsive to determining that the outcome event includes the trigger event, selecting a second set of symbols associated with respective positions of each of the reels as a bonus outcome event of the reel-based game. A win multiplier associated with the bonus game may be set to an initial value.

Next, block 1310 includes storing the second set of symbols in the memory.

Next, block 1312 includes adjusting the value of the win multiplier. The value of the win multiplier may be increased in response to a non-winning bonus outcome event. The value of the win multiplier may also be reset to the initial value in response to a winning bonus outcome event.

Next, block 1314 includes determining that the predetermined number of bonus outcome events have been performed.

Next, block 1316 includes, responsive to determining that the predetermined number of bonus outcome events have been performed, performing one or more additional bonus outcome events of the reel-based game until a further winning outcome occurs. The value of the win multiplier may be increased in response to a further non-winning outcome of an iteration of the one or more additional bonus outcome events

In some embodiments, performing the one or more additional bonus outcome events may occur when the value of the win multiplier is greater than the initial value when the predetermined number of bonus outcome events have been performed.

In some embodiments, when a set of symbols selected for an instance of the bonus outcome events of the bonus game includes a winning combination, a bonus payout amount associated with the selected set of symbols may be determined. A multiplied bonus payout amount may be determined by multiplying the bonus payout amount by the win multiplier. An indication of the multiplied bonus payout amount may be transmitted to the client machine.

In some embodiments, the client machine may be associated with a credit account. The credit account may be debited to play the base game, credited in response to the trigger event, and credited by the multiplied bonus payout amount.

In some embodiments, the initial value of the win multiplier may be 2.

In some embodiments, the win multiplier associated with the bonus game may range from 2 to 7 in increments of 1.

In some embodiments, increasing the value of the win multiplier may include adding at least 1 to the value of the win multiplier.

In some embodiments, the selected second set of symbols may include a wild symbol that is substitutable for other symbols in the reel-based game.

In some embodiments, each reel may comprise a respective cyclical sequence of symbols. Selecting the second set of symbols associated with respective positions of each of the reels may involve, for each reel, randomly selecting a respective reel position that displays a subsequence of the symbols on the reel that are part of the selected symbol set.

In some embodiments, selecting the second set of symbols associated with respective positions of each of the reels may involve simulating a spin of each of the reels.

In some embodiments, when the value of the win multiplier is increased in response to the non-winning bonus outcome event, the client machine may be caused to display an animation of the value of the win multiplier increasing.

In some embodiments, when the value of the win multiplier is reset to the initial value in response to the winning bonus outcome event, the client machine may be caused to display an animation of the value of the win multiplier resetting to the initial value.

In some embodiments, the base game and the bonus game may have five reels and each of the five reels displays three symbols at a time.

In some embodiments, the trigger event for the bonus game may include the first set of symbols including at least k trigger symbols. The value of k may be at least 2.

In some embodiments, the gaming machine may simultaneously execute base games or bonus games in real-time on behalf of at least 30 client machines. Each of the at least 30 client machines may communicate with the gaming machine by way of a wide-area packet-switched network.

In some cases, the one or more processors may simultaneously execute reel-based games in real time on behalf of more or fewer than 30 client machines. For instance, this simultaneous execution may involve 10, 20, 50, 100, or 1000 client machines, or another extent of client machines.

Particularly, simultaneous execution of such a large number of reel-based games in real time necessitates computer implementation. When taking part in an online game, such as the reel-based games disclosed herein, players expect results of reel spin or symbol replacement operations to be displayed on their respective client machines in an expeditious fashion (e.g., in real time, such as a few seconds at most per either of these operations). Failure to do so may result in players becoming disinterested in the game. Consequently, the embodiments that include this simultaneous execution a large number of reel-based games in real time would not exist but for computer implementation thereof.

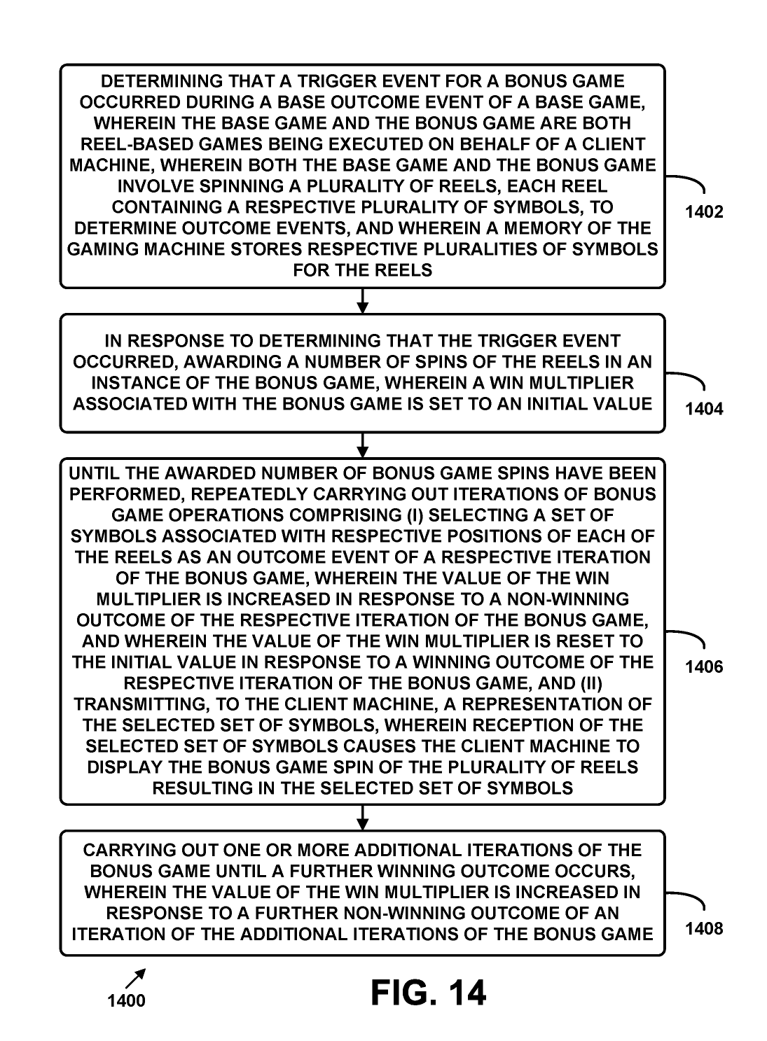

FIG. 14 depicts a flow chart showing a set of operations 1400 (or more simply, “the set 1400”) that can, for example, be carried out using server machine 100a and/or client machine 100b. To the extent that a client machine carries out any of the set 1400, these operations may also include displaying various types of information, such as symbol sets, payout amounts, and so on. Note that several of the operations described in connection with FIG. 14 parallel operations described in connection with FIGS. 6A-6D, FIGS. 11A-11D, FIGS. 12A-12C, and FIG. 13. As such, variations of the operations described in connection with FIGS. 6A-6D, FIGS. 11A-11D, FIGS. 12A-12C, and FIG. 13 are likewise applicable to the operations described in connection with FIG. 14.

Block 1402 of FIG. 14 may involve determining that a trigger event for a bonus game occurred during a base outcome event of a base game. The base game and the bonus game may both be reel-based games being executed on behalf of a client machine. Both the base game and the bonus game may involve spinning a plurality of reels, each reel containing a respective plurality of symbols, to determine outcome events. A memory of the gaming machine may store respective pluralities of symbols for the reels.

Block 1404 may involve, possibly in response to determining that the trigger event occurred, awarding a number of spins of the reels in an instance of the bonus game. A win multiplier associated with the bonus game may be set to an initial value.

Block 1406 may involve, until the awarded number of bonus game spins have been performed, repeatedly carrying out iterations of bonus game operations. The operations may include selecting a set of symbols associated with respective positions of each of the reels as an outcome event of a respective iteration of the bonus game. The value of the win multiplier may be increased in response to a non-winning outcome of the respective iteration of the bonus game. The value of the win multiplier may be reset to the initial value in response to a winning outcome of the respective iteration of the bonus game. The operations may also involve transmitting, to the client machine, a representation of the selected set of symbols. Reception of the selected set of symbols may cause the client machine to display the bonus game spin of the plurality of reels resulting in the selected set of symbols.

Next, block 1408 may involve carrying out one or more additional iterations of the bonus game until a further winning outcome occurs. The value of the win multiplier may be increased in response to a further non-winning outcome of an iteration of the additional iterations of the bonus game.

In some embodiments, carrying out the one or more additional iterations of the bonus game may occur when the value of the win multiplier is greater than the initial value when the awarded number of bonus game spins have been performed.

In some embodiments, the one or more additional iterations of the bonus game may be performed after the awarded number of bonus game spins have been performed.

In some embodiments, the selected set of symbols may include a winning combination. A bonus payout amount associated with the selected symbol set may be determined. A multiplied bonus payout amount may be determined by multiplying the bonus payout amount by the win multiplier. An indication of the multiplied bonus payout amount may additionally be transmitted to the client machine.

In some embodiments, the client machine may be associated with a credit account. The credit account may be debited to play the base game, credited in response to the trigger event, and credited by the multiplied bonus payout amount.

In some embodiments, the initial value of the win multiplier may be 2.

In some embodiments, the win multiplier associated with the bonus game may range from 2 to 7 in increments of 1.

In some embodiments, increasing the value of the win multiplier may include adding at least 1 to the value of the win multiplier.

In some embodiments, the selected set of symbols may include a wild symbol that is substitutable for other symbols in the reel-based game.

In some embodiments, each reel may include a respective cyclical sequence of symbols. Selecting the set of symbols associated with respective positions of each of the reels may include, for each reel, randomly selecting a respective reel position that displays a subsequence of the symbols on the reel that are part of the selected symbol set.

In some embodiments, selecting the set of symbols associated with respective positions of each of the reels may include simulating a spin of each of the reels.

In some embodiments, when the value of the win multiplier is increased in response to the non-winning outcome of the respective iteration of the bonus game, causing the client machine to display the bonus game spin may involve causing the client machine to display an animation of the value of the win multiplier increasing.

In some embodiments, when the value of the win multiplier is reset to the initial value in response to the winning outcome of the respective iteration of the bonus game, causing the client machine to display the bonus game spin may involve causing the client machine to display an animation of the value of the win multiplier resetting to the initial value.

In some embodiments, the base game and the bonus game may have five reels and each of the five reels may display three symbols at a time.

In some embodiments, the trigger event for the bonus game may include the base outcome event of the base game including at least k trigger symbols. The value of k may be at least 2.

In some embodiments, the gaming machine may simultaneously execute base games or bonus games in real-time on behalf of at least 30 client machines. Each of the at least 30 client machines may communicate with the gaming machine by way of a wide-area packet-switched network.

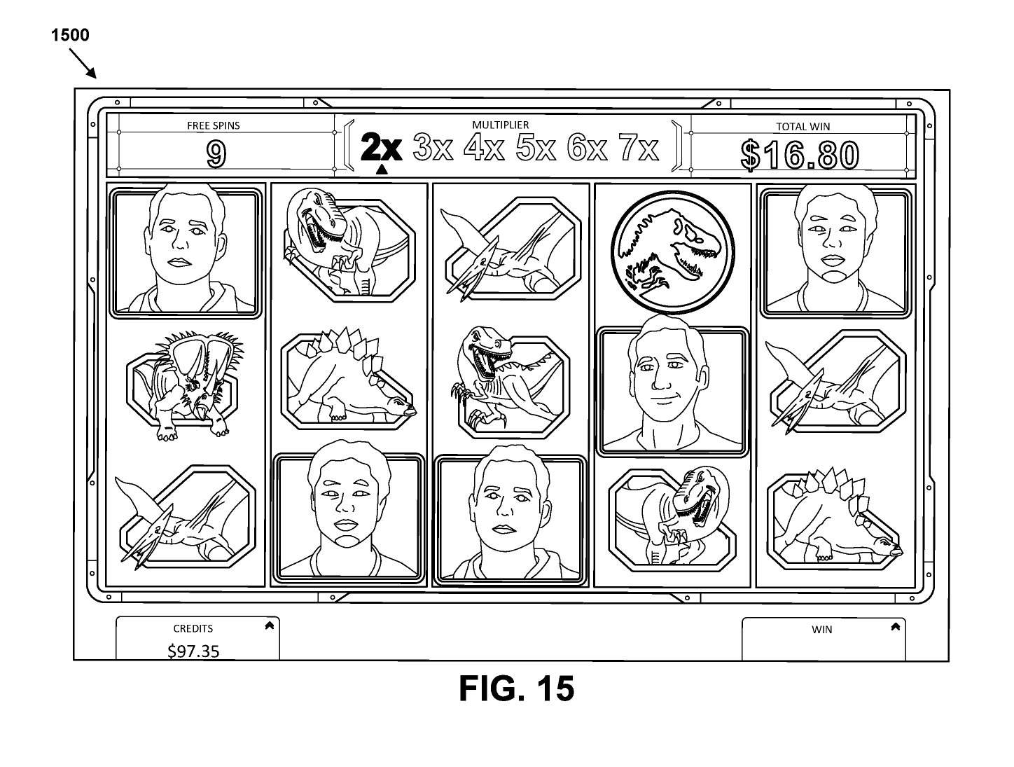

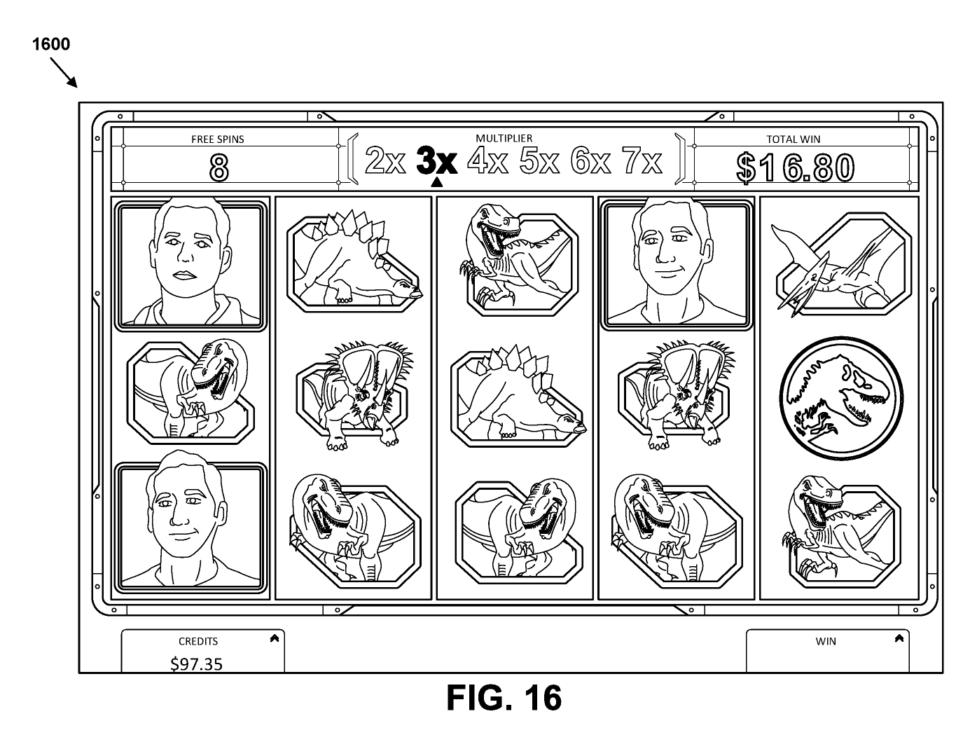

FIG. 15 illustrates an example indication and animation of the win multiplier. In FIG. 15, display 1500 depicts symbols, including a WILD symbol at position C4, R1, on a five-column, three-row matrix of symbols. The win multiplier is shown at the top and center of the display. In particular, the win multiplier displays all possible candidate values that the win multiplier can take on. The current value of the win multiplier is indicated by “lighting up” one of the candidate values (e.g., the value 2× in display 1500) while all other candidate values are dimmed. Alternatively, the current value of the win multiplier may be indicated by changing the color of the appropriate candidate value. The symbol combination illustrated on display 1500 does not include a winning symbol combination. Thus, the value of the win multiplier may be increased from 2× to 3×, as illustrated in FIG. 16. The increase may be animated by gradually dimming down the 2× value while gradually increasing the brightness of the 3× value.

FIG. 16 illustrated display 1600 depicting a second set of bonus symbols selected as an outcome event for an iteration of the bonus game subsequent to that shown in FIG. 15. FIG. 16 additionally illustrates the value 3×, as opposed to 2×, “lighting up” to indicate that the current value of the of the win multiplier is set at 3. When the symbol set shown in display 1600 does not include a winning combination of symbols, the value of the win multiplier may be again increased, this time from 3× to 4×. The increase may be animated in a manner similar to the increase from 2× to 3×. When the symbol set shown in display 1600 includes a winning combination of symbols, the value of the win multiplier may be reset from 3× to 2×. The resetting process may be animated in a manner similar to the increase from 2× to 3×.

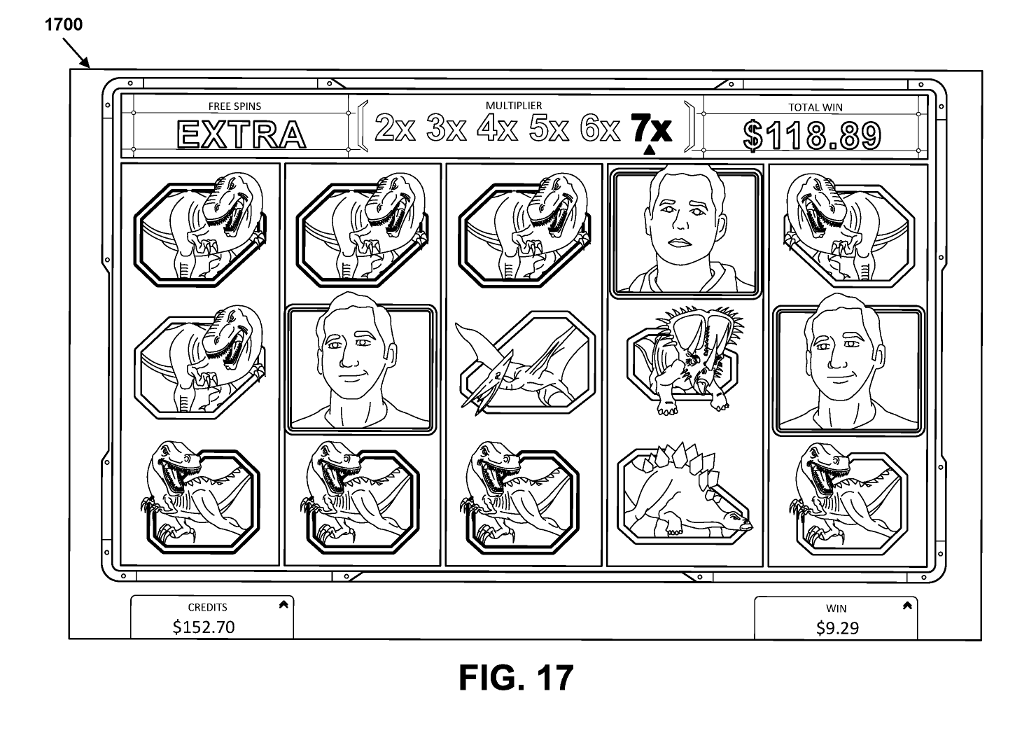

When the predetermined number of bonus game outcome events have been performed, additional bonus game iterations may be carried out until a winning outcome occurs. FIG. 17 illustrates display 1700 depicting a winning instance of an additional bonus game iteration. Namely, the “Free Spins” indicator in the upper left corner indicates that the current iteration is one of the additional bonus game iterations by displaying the word “EXTRA.” Additionally, display 1700 shows the win multiplier value being set to 7×. Thus, the payout amount associated with the winning symbol set will be multiplied by 7. The winning symbol set may be, for example, the combination of symbols at C1,R1; C2,R1; and C3,R1 as well as C1,R3; C2,R3; and C3,R3.

In a further embodiment that may be a variation of that of FIG. 13 and/or FIG. 14, a gaming system may be configured for a reel-based game. The reel-based game may be executed on behalf of a client machine, and involve spinning a plurality of reels to determine outcome events.

The gaming system may include a plurality of gaming devices each including at least one display device and a plurality of input devices including (i) an acceptor of a physical item associated with a monetary value, (ii) a validator configured to identify the physical item, and (iii) a cash-out button actuatable to cause an initiation of a payout associated with a credit account.

The gaming system may also include one or more gaming device processors, and one or more gaming device memory devices. The gaming memory devices may store (i) respective pluralities of symbols for the reels and (ii) a plurality of gaming device instructions executable by the one or more gaming device processors to perform any of the operations depicts in reference to FIG. 13 and/or FIG. 14.

### V. Conclusion

While one or more disclosed operations have been described as being performed by certain entities (e.g., machine 100, server machine 100a, or client machine 100b), one or more of the operations may be performed by any entity, including but not limited to those described herein. As such, while this disclosure includes examples in which the server machine 100a performs select operations and sends data to the client machine 100b, such that the client machine 100b may perform complementing operations and receive the data, variations may to those operations may be made while adhering to the general server-client dichotomy and the scope of the disclosed machines and methods.

For example, rather than the server machine 100a sending select data (e.g., a symbol set) to the client machine 100b, such that the client machine may generate and display appropriate images, the server machine 100a may itself generate the images and send them to the client machine 100b for display. Indeed, it will be appreciated by one of ordinary skill in the art that the “break point” between the server machine's operations and the client machine's operations may be varied.

Further, the described operations throughout this application need not be performed in the disclosed order, although in some examples, the recited order may be preferred. Also, not all operations need to be performed to achieve the desired advantages of disclosed machines and methods, and therefore not all operations are required.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

While examples have been described in terms of select embodiments, alterations and permutations of these embodiments will be apparent to those of ordinary skill in the art. Other changes, substitutions, and alterations are also possible without departing from the disclosed machines and methods in their broader aspects as set forth in the following claims.

What is claimed is:

1. A computer-implemented method involving a software application executed by a server machine on behalf of a client machine with a graphical display unit, wherein the software application involves graphically displaying, on vertical symbol display segments of the graphical display unit, animations that simulate spinning a plurality of reels, and wherein a memory of the server machine stores, for each reel of the plurality of reels, a respective plurality of symbols, subsets of which are displayable in a respective vertical symbol display segment corresponding to the reel, the computer-implemented method comprising:
determining, by a processor of the server machine, that a trigger event occurred in the software application;
in response to determining that the trigger event occurred, determining, by the processor, a number of spins of the reels, wherein a multiplier associated with the software application is set to an initial value;
until the determined number of spins have been performed, the processor repeatedly carrying out iterations of operations comprising:
selecting a set of symbols associated with respective positions of each of the reels in a respective spin of the reels, wherein a value of the multiplier is increased in response to any non-winning outcome on the set of symbols, and wherein the value of the multiplier is reset to the initial value in response to any winning outcome on the set of symbols, and
causing the graphical display unit to display an animation that simulates (i) the respective spin of the reels resulting in the vertical symbol display segments displaying the set of symbols, and (ii) the multiplier increasing when a non-winning outcome appears on the set of symbols; and
carrying out, by the processor, one or more additional spins of the reels until any further winning outcome occurs, wherein the value of the multiplier is increased in response to any further non-winning outcomes resulting from the one or more additional spins of the reels.

2. The method of claim 1, wherein carrying out the one or more additional spins of the reels occurs when the value of the multiplier is greater than the initial value when the determined number of spins have been performed.

3. The method of claim 1, wherein the one or more additional spins of the reels are carried out after the determined number of spins have been performed.

4. The method of claim 1, wherein the set of symbols includes a winning combination, and wherein the operations further comprise:
determining a bonus payout amount associated with the set of symbols;
determining a multiplied bonus payout amount by multiplying the bonus payout amount by the multiplier; and
wherein the animation also displays the multiplied bonus payout amount.

5. The method of claim 4, wherein the client machine is associated with a credit account, and wherein the credit account is debited prior to the trigger event occurring, credited in response to the trigger event occurring, and credited by the multiplied bonus payout amount.

6. The method of claim 1, wherein the initial value of the multiplier is 2.

7. The method of claim 1, wherein the multiplier ranges in value from 2 to 7 in increments of 1.

8. The method of claim 1, wherein increasing the value of the multiplier comprises adding at least 1 to the multiplier.

9. The method of claim 1, wherein each reel comprises a respective cyclical sequence of symbols, and wherein selecting the set of symbols associated with respective positions of each of the reels comprises:
for each reel, randomly selecting a respective reel position that displays, on the associated vertical symbol display segment, a subsequence of the symbols on the reel that are part of the set of symbols.

10. The method of claim 1, wherein, when the value of the multiplier is increased in response to a non-winning outcome, the animation displays the value of the multiplier increasing.

11. The method of claim 1, wherein, when the value of the multiplier is reset to the initial value in response to a winning outcome, the animation displays the value of the multiplier resetting to the initial value.

12. The method of claim 1, wherein the software application includes five reels and each of the five reels contributes three symbols to the set of symbols.

13. The method of claim 1, wherein the processor simultaneously executes the software application in real-time on behalf of at least 30 client machines, and wherein each of the at least 30 client machines communicates with the server machine by way of a wide-area packet-switched network.

14. A non-transitory computer-readable medium having stored thereon program instructions that define a software application, wherein the software application is executed by a server machine on behalf of a client machine with a graphical display unit, wherein the software application involves graphically displaying, on vertical symbol display segments of the graphical display unit, animations that simulate spinning a plurality of reels, wherein a memory of the server machine stores, for each reel of the plurality of reels, a respective plurality of symbols, subsets of which are displayable in a respective vertical symbol display segment corresponding to the reel, and wherein, upon execution by the server machine, the program instructions cause the server machine to perform operations comprising:
determining that a trigger event occurred in the software application;
in response to determining that the trigger event occurred, determining a number of spins of the reels, wherein a multiplier associated with the software application is set to an initial value;
until the determined number of spins have been performed, repeatedly carrying out iterations of operations comprising:
selecting a set of symbols associated with respective positions of each of the reels in a respective spin of the reels, wherein a value of the multiplier is increased in response to any non-winning outcome on the set of symbols, and wherein the value of the multiplier is reset to the initial value in response to any winning outcome on the set of symbols, and
causing the graphical display unit to display an animation that simulates (i) the respective spin of the reels resulting in the vertical symbol display segments displaying the set of symbols, and (ii) the multiplier increasing when a non-winning outcome appears on the set of symbols; and
carrying out one or more additional spins of the reels until any further winning outcome occurs, wherein the value of the multiplier is increased in response to any further non-winning outcomes resulting from the one or more additional spins of the reels.

15. The non-transitory computer-readable medium of claim 14, wherein carrying out the one or more additional spins of the reels occurs when the value of the multiplier is greater than the initial value when the determined number of spins have been performed.

16. The non-transitory computer-readable medium of claim 14, wherein the one or more additional spins of the reels are carried out after the determined number of spins have been performed.

17. The non-transitory computer-readable medium of claim 14, wherein each reel comprises a respective cyclical sequence of symbols, and wherein selecting the set of symbols associated with respective positions of each of the reels comprises:
for each reel, randomly selecting a respective reel position that displays, on the associated vertical symbol display segment, a subsequence of the symbols on the reel that are part of the set of symbols.

18. The non-transitory computer-readable medium of claim 14, wherein, when the value of the multiplier is increased in response to the non-winning outcome of the respective iteration of the bonus game, the animation displays the value of the multiplier increasing.

19. The non-transitory computer-readable medium of claim 14, wherein, when the value of the multiplier is reset to the initial value in response to the winning outcome, the animation displays the value of the multiplier resetting to the initial value.

20. A system configured for executing a software application, wherein the software application involves graphically displaying, on vertical symbol display segments, animations that simulate spinning a plurality of reels, and wherein the system stores, for each reel of the plurality of reels, a respective plurality of symbols, subsets of which are displayable in a respective vertical symbol display segment corresponding to the reel, the system comprising:
a client machine including a client machine processor, a client machine memory, a graphical display unit, and a plurality of input devices, wherein the plurality of input devices include: (i) an acceptor of a physical item associated with a monetary value, (ii) a validator configured to identify the physical item, and (iii) a cash-out button actuatable to cause an initiation of a payout associated with a credit account; and
program instructions executable to perform operations comprising:
determining that a trigger event occurred in the software application;
in response to determining that the trigger event occurred, determining a number of spins of the reels, wherein a multiplier associated with the software application is set to an initial value;
until the determined number of spins have been performed, repeatedly carrying out iterations of operations comprising:
selecting a set of symbols associated with respective positions of each of the reels in a respective spin of the reels, wherein a value of the multiplier is increased in response to any non-winning outcome on the set of symbols, and wherein the value of the multiplier is reset to the initial value in response to any winning outcome on the set of symbols, and
causing the graphical display unit to display an animation that simulates (i) the respective spin of the reels resulting in the vertical symbol display segments displaying the set of symbols, and (ii) the multiplier increasing when a non-winning outcome appears on the set of symbols; and
carrying out one or more additional spins of the reels until any further winning outcome occurs, wherein the value of the multiplier is increased in response to any further non-winning outcomes resulting from the one or more additional spins of the reels.
